(19) United States
(12) Patent Application Publication
(10) Pub. No.: US 2024/0322978 A1
(43) Pub. Date: Sep. 26, 2024

(54) METHOD AND DEVICE IN NODES USED FOR WIRELESS COMMUNICATION

(71) Applicants: Zheng LIU, Shanghai (CN); Xiaobo ZHANG, Shanghai (CN)

(72) Inventors: Zheng LIU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/736,549

(22) Filed: Jun. 7, 2024

Related U.S. Application Data
(63) Continuation of application No. PCT/CN2022/136423, filed on Dec. 5, 2022.

(30) Foreign Application Priority Data
Dec. 8, 2021 (CN) 202111490609.8

(51) Int. Cl. H04L 5/00

(52) U.S. Cl. CPC H04L 5/0053; H04L 5/0007

(57) ABSTRACT

The node receives a first information block and a second information block, the first information block determining a first RE set, the first RE set being used for first-type reference signals; and monitors control channel candidates in a first control resource set, the second information block determines a characteristic resource subset, the characteristic resource subset comprising multiple time-frequency units; the characteristic resource subset and the first RE set are in a relationship other than a characteristic relationship, the characteristic relationship being one of a first relationship or a second relationship; the first relationship includes the presence of at least one overlapping RE between only part of time-frequency units of the characteristic resource subset and the first RE set, while the second relationship includes that there exists at least one overlapping RE between the characteristic resource subset and the first RE set. This application improves performance and reduces complexity.

### CROSS REFERENCE TO RELATED APPLICATIONS

This application is the continuation of the international patent application No. PCT/CN2022/136423, filed on Dec. 5, 2022, and claims the priority benefit of Chinese Patent Application No. 202111490609.8 filed on Dec. 8, 2021, the full disclosure of which is incorporated herein by reference.

### BACKGROUND

### Technical Field

The present application relates to transmission methods and devices in wireless communication systems, and in particular to a scheme and device for transmitting control channels in wireless communications.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 session to standardize the NR.

The coexistence and smooth evolution of new radio (NR) technologies and other radio technologies (e.g., LTE) are of great value for spectrum sharing and its commercial deployment, therefore, the 3GPP has been committed to ensuring the effective coexistence and smooth transition between NR technologies and other air interface technologies during the evolution of NR technologies.

### SUMMARY

In NR systems, the capacity of the control channels often becomes a bottleneck in the capacity of the entire system. To address the transmission problem with respect to the control channel in NR, the present application discloses a solution. It should be noted that in the description of the present application, the coexistence of NR and other air interface technologies or spectrum sharing is only taken as a typical application scenario or example; the present application is also applicable to other scenarios facing similar problems (e.g., scenarios with higher requirements for robustness or capacity of the control channel or scenarios in which there are collisions between the control channel and other channels or signals using the same air interface technology), including but not limited to capacity enhancement scenarios, Internet of Things (IoT), Ultra Reliable Low Latency Communication (URLLC) networks, and V2X, etc., and similar technical results can be achieved. Additionally, the adoption of a unified solution for various scenarios, including but not limited to spectrum sharing scenarios, contributes to the reduction of hardcore complexity and costs. In the case of no conflict, the embodiments of a first node and the characteristics in the embodiments may be applied to a second node, and vice versa. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:
receiving a first information block and receiving a second information block, the first information block being used to determine a first RE set, the first RE set comprising at least one RE, and any RE in the first RE set being used for first-type reference signals; and
monitoring control channel candidates in a first control resource set, the first control resource set comprising multiple REs, and the first control resource set comprising at least one RE being used for second-type reference signals, the second-type reference signals and the first-type reference signals being two different types of reference signals, the second-type reference signals being used for demodulation of control channels;
herein, the second information block is used to determine a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set.

In one embodiment, complexity is reduced while increasing control channel capacity by means of the characteristic resource subset and the first RE set being in a relationship other than the characteristic relationship and that the characteristic relationship can only be one of the first relationship or the second relationship.

In one embodiment, that the first relationship includes that there exists at least one overlapping RE between only part of time-frequency units of the characteristic resource subset and the first RE set reduces complexity while ensuring performance of channel estimation.

According to one aspect of the present application, the above method is characterized in that the first information block comprises a first sub-information-block and a second sub-information-block, the first sub-information-block being used to determine a number of antenna ports of the first-type reference signals, the second sub-information-block being used to determine a frequency-domain location of REs comprised by the first RE set, and at least one of the number of the antenna ports of the first-type reference signals or the frequency-domain location of the REs comprised by the first RE set being used to determine the characteristic relationship between the first relationship or the second relationship.

In one embodiment, determining the characteristic relationship based on at least one of the number of the antenna ports of the first-type reference signals or the frequency-domain location of the REs comprised by the first RE set avoids an overly conservative design and optimizes system performance.

According to one aspect of the present application, the above method is characterized in that the second information block is used to determine precoding granularity of the first control resource set, and a number of the time-frequency units in the characteristic resource subset is related to the precoding granularity of the first control resource set.

According to one aspect of the present application, the above method is characterized in comprising:
transmitting a third information block;
herein, the third information block is used to indicate a capability of the first node, and at least one of the capability of the first node or an index of the first control resource set is used to determine the characteristic relationship between the first relationship or the second relationship.

In one embodiment, the characteristic relationship is determined based on at least one of the capability of the first node or an index of the first control resource set which provides flexibility in product design while ensuring performance of the most important control channels.

According to one aspect of the present application, the above method is characterized in that the precoding granularity of the first control resource set refers to all contiguous RBs, and a number of non-contiguous RB subset(s) included in the first control resource set in frequency domain is no greater than a first threshold, the first threshold being a positive integer greater than 1; the first threshold is fixed, or the first threshold is related to whether the characteristic relationship is the first relationship or the second relationship.

In one embodiment, the design of the first threshold provides a scheme for flexible optimization of performance and complexity.

According to one aspect of the present application, the above method is characterized in that the first information block is used to determine at least one of whether there is quasi-colocation between the first-type reference signals and the second-type reference signals, or the type of quasi-colocation relationship between the first-type reference signals and the second-type reference signals.

In one embodiment, quasi-colocation between the first-type reference signals and the second-type reference signals may improve reception performance of the control channels.

According to one aspect of the present application, the above method is characterized in comprising:
receiving a fourth information block;
herein, a first quantity value is equal to a number of time-domain symbols occupied in time domain by the first control resource set, and a number of time-domain symbols occupied in time domain by the characteristic resource subset is equal to the first quantity value; the fourth information block is used to determine a target quantity set, the target quantity set including multiple quantity values, and the second information block is used to determine the first quantity value out of the target quantity set; the first quantity value is used to determine the characteristic relationship between the first relationship or the second relationship.

The present application provides a method in a second node for wireless communications, comprising:
transmitting a first information block and transmitting a second information block, the first information block being used to indicate a first RE set, the first RE set comprising at least one RE, and any RE in the first RE set being used for first-type reference signals; and
transmitting control channel candidates in a first control resource set, the first control resource set comprising multiple REs, and the first control resource set comprising at least one RE being used for second-type reference signals, the second-type reference signals and the first-type reference signals being two different types of reference signals, the second-type reference signals being used for demodulation of control channels;
herein, the second information block is used to indicate a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set.

According to one aspect of the present application, the above method is characterized in that the first information block comprises a first sub-information-block and a second sub-information-block, the first sub-information-block being used to determine a number of antenna ports of the first-type reference signals, the second sub-information-block being used to determine a frequency-domain location of REs comprised by the first RE set, and at least one of the number of the antenna ports of the first-type reference signals or the frequency-domain location of the REs comprised by the first RE set being used to determine the characteristic relationship between the first relationship or the second relationship.

According to one aspect of the present application, the above method is characterized in that the second information block is used to determine precoding granularity of the first control resource set, and a number of the time-frequency units in the characteristic resource subset is related to the precoding granularity of the first control resource set.

According to one aspect of the present application, the above method is characterized in comprising:
receiving a third information block;
herein, the third information block is used to indicate a capability of the first node, and at least one of the capability of the first node or an index of the first control resource set is used to determine the characteristic relationship between the first relationship or the second relationship.

According to one aspect of the present application, the above method is characterized in that the precoding granularity of the first control resource set refers to all contiguous RBs, and a number of non-contiguous RB subset(s) included in the first control resource set in frequency domain is no greater than a first threshold, the first threshold being a positive integer greater than 1; the first threshold is fixed, or the first threshold is related to whether the characteristic relationship is the first relationship or the second relationship.

According to one aspect of the present application, the above method is characterized in that the first information block is used to indicate at least one of whether there is quasi-colocation between the first-type reference signals and the second-type reference signals, or the type of quasi-colocation relationship between the first-type reference signals and the second-type reference signals.

According to one aspect of the present application, the above method is characterized in comprising:
transmitting a fourth information block;
herein, a first quantity value is equal to a number of time-domain symbols occupied in time domain by the first control resource set, and a number of time-domain symbols occupied in time domain by the characteristic resource subset is equal to the first quantity value; the fourth information block is used to indicate a target quantity set, the target quantity set including multiple quantity values, and the second information block is used to determine the first quantity value out of the target quantity set; the first quantity value is used to determine the characteristic relationship between the first relationship or the second relationship.

The present application provides a first node for wireless communications, comprising:
a first transceiver, receiving a first information block and receiving a second information block, the first information block being used to determine a first RE set, the first RE set comprising at least one RE, and any RE in the first RE set being used for first-type reference signals; and
a first receiver, monitoring control channel candidates in a first control resource set, the first control resource set comprising multiple REs, and the first control resource set comprising at least one RE being used for second-type reference signals, the second-type reference signals and the first-type reference signals being two different types of reference signals, the second-type reference signals being used for demodulation of control channels;
herein, the second information block is used to determine a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set.

The present application provides a second node for wireless communications, comprising:
a second transceiver, transmitting a first information block and transmitting a second information block, the first information block being used to indicate a first RE set, the first RE set comprising at least one RE, and any RE in the first RE set being used for first-type reference signals; and
a first transmitter, transmitting control channel candidates in a first control resource set, the first control resource set comprising multiple REs, and the first control resource set comprising at least one RE being used for second-type reference signals, the second-type reference signals and the first-type reference signals being two different types of reference signals, the second-type reference signals being used for demodulation of control channels;
herein, the second information block is used to indicate a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first information block, a second information block and monitoring of control channel candidates according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first node and a second node according to one embodiment of the present application.

FIG. 5 illustrates a flowchart of radio signal transmission according to one embodiment of the present application.

FIG. 6 illustrates a schematic diagram of first-type reference signals according to one embodiment of the present application.

FIG. 7 illustrates a schematic diagram of the precoding granularity of a first control resource set according to one embodiment of the present application.

FIG. 8 illustrates a schematic diagram of the determination of a characteristic relationship according to one embodiment of the present application.

FIG. 9 illustrates a schematic diagram of a first threshold according to one embodiment of the present application.

FIG. 10 illustrates a schematic diagram of the relationship between first-type reference signals and second-type reference signals according to one embodiment of the present application.

FIG. 11 illustrates a schematic diagram of a first quantity value according to one embodiment of the present application.

FIG. 12 illustrates a structure block diagram of a processing device in a first node according to one embodiment of the present application.

FIG. 13 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

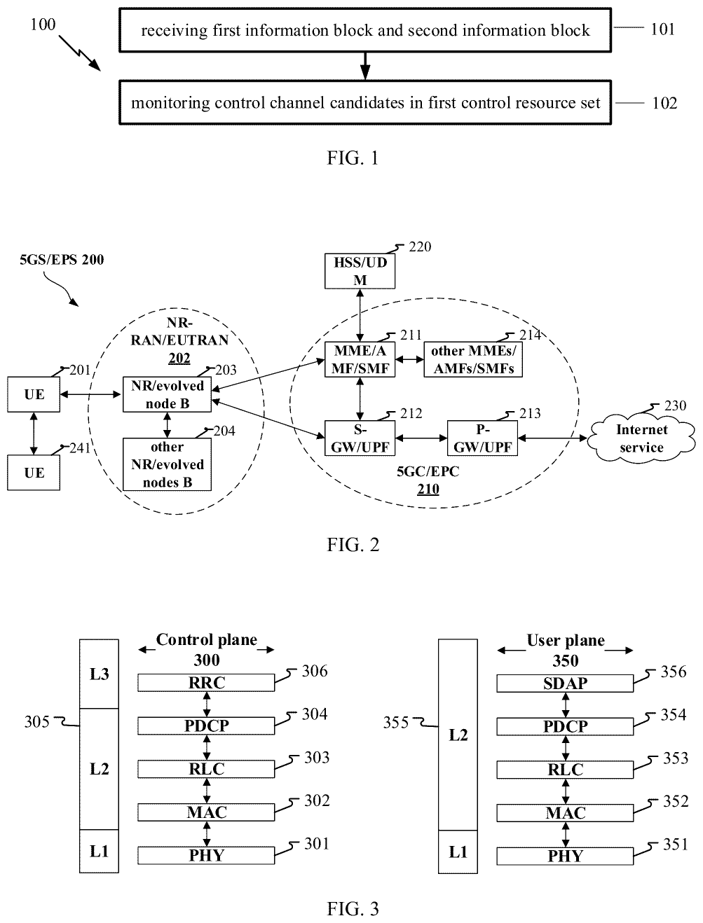

Embodiment 1 illustrates a flowchart of a first information block, a second information block and monitoring of control channel candidates according to one embodiment of the present application, as shown in FIG. 1. In FIG. 1, each step represents a step, it should be particularly noted that the sequence order of each box herein does not restrict a chronological order of steps marked respectively by these boxes.

In Embodiment 1, the first node in the present application receives a first information block and receives a second information block in step 101, the first information block being used to determine a first RE set, the first RE set comprising at least one RE, and any RE in the first RE set being used for first-type reference signals; and the first node monitors control channel candidates in a first control resource set in step 102, the first control resource set comprising multiple REs, and the first control resource set comprising at least one RE being used for second-type reference signals, the second-type reference signals and the first-type reference signals being two different types of reference signals, the second-type reference signals being used for demodulation of control channels; herein, the second information block is used to determine a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set.

In one embodiment, the first information block is transmitted via an air interface or a wireless interface.

In one embodiment, the first information block comprises all or part of a higher layer signaling or a physical layer signaling.

In one embodiment, the first information block comprises all or part of a Radio Resource Control (RRC) layer signaling or a Medium Access Control (MAC) layer signaling.

In one embodiment, the first information block comprises all or part of a System Information Block (SIB).

In one embodiment, the first information block is Cell Specific or UE-specific.

In one embodiment, the first information block is Per Bandwidth-Part (BWP) Configured.

In one embodiment, the first information block comprises all or partial fields in a Downlink Control Information (DCI) Format.

In one embodiment, the first information block comprises all or part of a field “lte-CRS-ToMatchAround” in an RRC layer signaling.

In one embodiment, the first information block comprises all or part of a field “lte-CRS-PatternList1-r16” in an RRC layer signaling.

In one embodiment, the first information block comprises all or part of a field “lte-CRS-PatternList2-r16” in an RRC layer signaling.

In one embodiment, the first information block comprises all or part of fields in an Information Element (IE) “RateMatchPatternLTE-CRS” in an RRC layer signaling.

In one embodiment, the first information block comprises all or part of fields in an Information Element (IE) “CSI-ResourceConfig” in an RRC layer signaling.

In one embodiment, the first information block comprises all or part of fields in an Information Element (IE) “CSI-SSB-ResourceSet” in an RRC layer signaling.

In one embodiment, the first information block comprises all or part of fields in an Information Element (IE) “CSI-IM-Resource” in an RRC layer signaling.

In one embodiment, the first information block comprises all or part of fields in an Information Element (IE) “SSB-Index” in an RRC layer signaling.

In one embodiment, the first information block comprises all or part of fields in an Information Element (IE) “ssb-periodicityServingCell” in an RRC layer signaling.

In one embodiment, the first information block comprises all or part of fields in an Information Element (IE) “LTE-CRS-PatternList-r16” in an RRC layer signaling.

In one embodiment, the first information block comprises all or part of fields in an Information Element (IE) “ServingCellConfig” in an RRC layer signaling.

In one embodiment, the first information block comprises all or part of fields in an Information Element (IE) “ServingCellConfigCommon” in an RRC layer signaling.

In one embodiment, the first information block comprises more than one sub-information-block, and each sub-information-block comprised in the first information block is an Information Element (IE) or a field in an RRC layer signaling to which the first information block belongs; one or more sub-information-blocks in the first information block is/are used to determine the first RE set. In one subsidiary embodiment of the above embodiment, one or more sub-information-blocks included in the first information block is/are used to determine a RE subset list, the RE subset list including a plurality of RE subsets, the RE subsets in the RE subset list constituting the first RE set.

In one embodiment, the statement in the claims that “the first information block is used to determine a first RE set” includes the following meaning: the first information block is used by the first node in the present application to determine the first RE set.

In one embodiment, the statement in the claims that “the first information block is used to determine a first RE set” includes the following meaning: the first information block is used to explicitly or implicitly indicate the first RE set.

In one embodiment, the statement in the claims that “the first information block is used to determine a first RE set” includes the following meaning: the first information block is used to explicitly or implicitly indicate the number and distribution of REs included in the first RE set.

In one embodiment, the statement in the claims that “the first information block is used to determine a first RE set” includes the following meaning: the first information block is used to explicitly or implicitly indicate the number of antenna ports of the first-type reference signals and the frequency-domain location of REs included in the first RE set.

In one embodiment, the statement in the claims that “the first information block is used to determine a first RE set” includes the following meaning: the first information block is used to explicitly or implicitly indicate the number of antenna ports of the first-type reference signals.

In one embodiment, the statement in the claims that “the first information block is used to determine a first RE set” includes the following meaning: the first information block is used to explicitly or implicitly indicate the frequency-domain location of REs included in the first RE set.

In one embodiment, the statement in the claims that “the first information block is used to determine a first RE set” includes the following meaning: the first information block is used to explicitly or implicitly indicate the v-shift corresponding to REs included in the first RE set.

In one embodiment, the statement in the claims that “the first information block is used to determine a first RE set” includes the following meaning: the first information block is used to explicitly or implicitly indicate at least one of the number of antenna ports of the first-type reference signals, the v-shift corresponding to the REs included in the first RE set, the bandwidth of LTE carrier to which the first RE set belongs in frequency domain, the downlink center frequency of the LTE carrier to which the first RE set belongs in frequency domain, or the subframe to which the first RE set belongs in time domain.

In one embodiment, the second information block is transmitted via an air interface or a wireless interface.

In one embodiment, the second information block comprises all or part of a higher layer signaling or a physical layer signaling.

In one embodiment, the second information block comprises all or part of a Radio Resource Control (RRC) layer signaling or a Medium Access Control (MAC) layer signaling.

In one embodiment, the second information block comprises all or part of a System Information Block (SIB).

In one embodiment, the second information block is Cell Specific or UE-specific.

In one embodiment, the second information block is Per Bandwidth-Part (BWP) Configured.

In one embodiment, the second information block comprises all or partial fields in a Downlink Control Information (DCI) Format.

In one embodiment, the second information block comprises all or part of a field “controlResourceSetToAddModList” in an RRC layer signaling.

In one embodiment, the second information block comprises all or part of a field “controlResourceSetToReleaseList” in an RRC layer signaling.

In one embodiment, the second information block comprises all or part of a field “searchSpacesToAddModList” in an RRC layer signaling.

In one embodiment, the second information block comprises all or part of a field “searchSpacesToReleaseList” in an RRC layer signaling.

In one embodiment, the second information block comprises all or part of fields in an Information Element (IE) “pdcch-ConfigSIB1” in an RRC layer signaling.

In one embodiment, the second information block comprises all or part of fields in an Information Element (IE) “BWP-DownlinkCommon” in an RRC layer signaling.

In one embodiment, the second information block comprises all or part of fields in an Information Element (IE) “pdcch-ConfigCommon” in an RRC layer signaling.

In one embodiment, the second information block comprises all or part of fields in an Information Element (IE) “BWP-DownlinkDedicated” in an RRC layer signaling.

In one embodiment, the second information block comprises all or part of fields in an Information Element (IE) “pdcch-Config” in an RRC layer signaling.

In one embodiment, the second information block comprises all or part of fields in an Information Element (IE) “ControlResourceSet” in an RRC layer signaling.

In one embodiment, the second information block comprises all or part of fields in an Information Element (IE) “SearchSpace” in an RRC layer signaling.

In one embodiment, the second information block comprises all or part of a field “frequencyDomainResources” in an IE “ControlResourceSet”.

In one embodiment, the second information block comprises all or part of a field “duration” in an IE “ControlResourceSet”.

In one embodiment, the second information block comprises all or part of a field “reg-BundleSize” in an IE “ControlResourceSet”.

In one embodiment, the second information block comprises all or part of a field “precoderGranularity” in an IE “ControlResourceSet”.

In one embodiment, the first information block is before the second information block.

In one embodiment, the first information block is after the second information block.

In one embodiment, the first information block and the second information block are transmitted through a same physical channel.

In one embodiment, the first information block and the second information block belong to two different fields in a same IE.

In one embodiment, the first information block and the second information block belong to two different IEs.

In one embodiment, the subcarrier spacing (SCS) of subcarriers occupied in frequency domain by any Resource Element (RE) included in the first RE set is equal to 15 kHz.

In one embodiment, the subcarrier spacing (SCS) of subcarriers occupied in frequency domain by any Resource Element (RE) included in the first RE set is equal to 7.5 kHz.

In one embodiment, the subcarrier spacing (SCS) of subcarriers occupied in frequency domain by any RE included in the first RE set is equal to a subcarrier spacing other than 15 kHz.

In one embodiment, all the REs included in the first RE set belong to a same slot in time domain.

In one embodiment, all the REs included in the first RE set belong to a same subframe in time domain.

In one embodiment, all the REs included in the first RE set belong to a same 5G NR slot in time domain.

In one embodiment, the REs included in the first RE set are periodically distributed in the time domain.

In one embodiment, the first RE set includes all REs that are used for the first-type reference signals.

In one embodiment, the first RE set includes part of REs that are used for the first-type reference signals.

In one embodiment, the first RE set comprises only REs that are used for the first-type reference signals belonging to a same serving cell or to a same Transmit Receive Point (TRP).

In one embodiment, the first RE set comprises REs that are used for the first-type reference signals belonging to different serving cells or to different Transmit Receive Points (TRPs).

In one embodiment, the first-type reference signal is Common Reference Signal (CRS).

In one embodiment, the first-type reference signal is Tracking Reference Signal (TRS).

In one embodiment, the first-type reference signal is Phase-Tracking Reference Signal (PTRS).

In one embodiment, the first-type reference signal is Positioning Reference Signal (PRS).

In one embodiment, the first-type reference signal is Remote Interference Measurement Reference Signal (RIM-RS).

In one embodiment, the first-type reference signal is Primary Synchronization Signal (PSS).

In one embodiment, the first-type reference signal is Secondary Synchronization Signal (SSS).

In one embodiment, the first-type reference signal is Synchronization Signal/Physical Broadcast Channel Block (SS/PBCH Block).

In one embodiment, the first-type reference signal is channel status information reference signal (CSI-RS).

In one embodiment, the first-type reference signal is Reference signal in Long Term Evolution (LTE).

In one embodiment, the first-type reference signal is CSI-RS in LTE.

In one embodiment, the first node of the present application assumes that any RE included in the first RE set is used for the first-type reference signals.

In one embodiment, the first-type reference signal resources are mapped to any RE included in the first RE set.

In one embodiment, the first-type reference signals occupy any RE included in the first RE set.

In one embodiment, any RE included in the first RE set is truthfully used for the first-type reference signals.

In one embodiment, the first RE set includes an RE that is actually not used for the first-type reference signals, but the first node of the present application assumes that any RE included in the first RE set is used for the first-type reference signals.

In one embodiment, the first control resource set is a Control Resource Set (CORESET).

In one embodiment, the first control resource set is a CORESET with an index or identifier equal to 0.

In one embodiment, the first control resource set is a CORESET with an index or identifier being non-zero.

In one embodiment, the subcarrier spacing (SCS) of subcarriers occupied in frequency domain by any RE included in the first control resource set is equal to 15 kHz.

In one embodiment, the subcarrier spacing (SCS) of subcarriers included in a bandwidth part (BWP) to which the first control resource set belongs in frequency domain is equal to 15 kHz.

In one embodiment, the subcarrier spacing (SCS) of subcarriers occupied in frequency domain by any RE included in the first control resource set is greater than 15 kHz.

In one embodiment, the first control resource set is a CORESET in a Monitoring Occasion (MO).

In one embodiment, the first control resource set is a CORESET that is associated to at least one Search Space Set.

In one embodiment, any control channel candidate monitored in the first control resource set is a PDCCH Candidate.

In one embodiment, any control channel candidate monitored in the first control resource set is a Monitored PDCCH Candidate.

In one embodiment, any control channel candidate monitored in the first control resource set is a PDCCH Candidate belonging to a search space set associated with the first control resource set.

In one embodiment, monitoring control channel candidates refers to Decoding of the control channel candidates.

In one embodiment, monitoring control channel candidates refers to Blind Decoding of the control channel candidates.

In one embodiment, monitoring control channel candidates refers to Decoding and CRC checking of the control channel candidates.

In one embodiment, monitoring control channel candidates refers to Decoding of the control channel candidates and CRC checking with the scrambling by a Radio Network Temporary Identity (RNTI).

In one embodiment, monitoring control channel candidates refers to Decoding of the control channel candidates based on one or more Format(s) of monitored DCI.

In one embodiment, the statement “monitoring control channel candidates in a first control resource set” in the claims comprises the following meaning: monitoring the control channel candidates belonging to the first control resource set.

In one embodiment, the statement “monitoring control channel candidates in a first control resource set” in the claims comprises the following meaning: monitoring the control channel candidates belonging to a search space set associated with the first control resource set.

In one embodiment, the statement “monitoring control channel candidates in a first control resource set” in the claims comprises the following meaning: monitoring the control channel candidates by which time-frequency resources occupied belong to the first control resource set.

In one embodiment, the statement “monitoring control channel candidates in a first control resource set” in the claims comprises the following meaning: monitoring at least one control channel candidate in the first control resource set.

In one embodiment, Control Channel Elements (CCEs) occupied by the control channel candidates monitored in the first control resource set belong to the first control resource set.

In one embodiment, the number of control channel candidates monitored in the first control resource set is greater than 1.

In one embodiment, the number of control channel candidates monitored in the first control resource set is equal to 1.

In one embodiment, the number of control channel candidates monitored in the first control resource set is signaling configured.

In one embodiment, the number of control channel candidates monitored in the first control resource set is equal to the number of control channel candidates included in a search space set associated with the first control resource set.

In one embodiment, the second-type reference signal is Demodulation Reference Signal (DMRS).

In one embodiment, the second-type reference signal is PDCCH DMRS.

In one embodiment, the second-type reference signal is PDCCH DMRS in 5G NR.

In one embodiment, the first control resource set includes a plurality of REs being used for the second-type reference signals.

In one embodiment, the first control resource set includes REs other than the REs being used for the second-type reference signals.

In one embodiment, the distribution of REs included in the first control resource set being used for the second-type reference signals in the first control resource set is fixed.

In one embodiment, the statement “the first control resource set comprising at least one RE being used for second-type reference signals” in the claims comprises the following meaning: the second-type reference signals are resource mapped to at least one RE included in the first control resource set.

In one embodiment, the statement “the first control resource set comprising at least one RE being used for second-type reference signals” in the claims comprises the following meaning: the second-type reference signals occupy at least one RE included in the first control resource set.

In one embodiment, the statement “the first control resource set comprising at least one RE being used for second-type reference signals” in the claims comprises the following meaning: at least one RE included in the first control resource set is used for transmission of the second-type reference signals.

In one embodiment, the statement “the first control resource set comprising at least one RE being used for second-type reference signals” in the claims comprises the following meaning: the first node in this application assumes that the first control resource set includes at least one RE being used for the second-type reference signals.

In one embodiment, the statement “the first control resource set comprising at least one RE being used for second-type reference signals” in the claims comprises the following meaning: the first control resource set includes at least one RE being actually used for the second-type reference signals.

In one embodiment, the statement “the first control resource set comprising at least one RE being used for second-type reference signals” in the claims comprises the following meaning: none of the REs in the first control resource set is actually used for the second-type reference signals, but the first node in this application assumes that the first control resource set includes at least one RE being used for the second-type reference signals.

In one embodiment, the first control resource set includes all the REs being used for the second-type reference signals.

In one embodiment, the first control resource set includes part of the REs being used for the second-type reference signals.

In one embodiment, the statement “the second-type reference signals being used for demodulation of control channels” in the claims comprises the following meaning: the second-type reference signal is a PDCCH demodulation reference signal.

In one embodiment, the statement “the second-type reference signals being used for demodulation of control channels” in the claims comprises the following meaning: the second-type reference signals are used for channel estimation during control channel demodulation.

In one embodiment, the statement “the second-type reference signals being used for demodulation of control channels” in the claims comprises the following meaning: a channel over which modulation symbols of the control channel transmitted on one antenna port are conveyed can be deduced from symbols of the second-type reference signals transmitted on the same antenna port.

In one embodiment, the statement “the second-type reference signals being used for demodulation of control channels” in the claims comprises the following meaning: when the second-type reference signals and the control channels being used for demodulation are within resources in which the first node of the present application assumes that the same precoding is employed, a channel over which modulation symbols of the control channel transmitted on one antenna port are conveyed can be deduced from symbols of the second-type reference signals transmitted on the same antenna port.

In one embodiment, the statement “the second-type reference signals and the first-type reference signals being two different types of reference signals” in the claims comprises the following meaning: the second-type reference signals and the first-type reference signals belong to two different Radio Access Technologies (RATs) respectively.

In one embodiment, the statement “the second-type reference signals and the first-type reference signals being two different types of reference signals” in the claims comprises the following meaning: the second-type reference signals and the first-type reference signals belong to 5G New Radio (NR) and LTE respectively.

In one embodiment, the statement “the second-type reference signals and the first-type reference signals being two different types of reference signals” in the claims comprises the following meaning: the second-type reference signals and the first-type reference signals both belong to 5G New Radio (NR) but the second-type reference signals are used for a different purpose than the first-type reference signals.

In one embodiment, the statement “the second-type reference signals and the first-type reference signals being two different types of reference signals” in the claims comprises the following meaning: the second-type reference signals are DMRS while the first-type reference signals are CRS.

In one embodiment, the statement “the second-type reference signals and the first-type reference signals being two different types of reference signals” in the claims comprises the following meaning: the second-type reference signals are DMRS while the first-type reference signals are SS/PBCH blocks.

In one embodiment, the statement “the second-type reference signals and the first-type reference signals being two different types of reference signals” in the claims comprises the following meaning: the second-type reference signals are PDCCH DMRS while the first-type reference signals are CRS.

In one embodiment, the statement “the second-type reference signals and the first-type reference signals being two different types of reference signals” in the claims comprises the following meaning: the second-type reference signals are DMRS while the first-type reference signals are CSI-RS.

In one embodiment, the statement “the second-type reference signals and the first-type reference signals being two different types of reference signals” in the claims comprises the following meaning: the second-type reference signals are reference signals reflecting an equivalent channel and the first-type reference signals are reference signals reflecting the actual channel.

In one embodiment, the statement “the second-type reference signals and the first-type reference signals being two different types of reference signals” in the claims comprises the following meaning: the second-type reference signals are reference signals having been through pre-coding while the first-type reference signals are reference signals not having been pre-coded.

In one embodiment, the characteristic resource subset and the first control resource set are equivalent or used interchangeably.

In one embodiment, the characteristic resource subset and the first control resource set are different.

In one embodiment, the characteristic resource subset belongs to the first control resource set.

In one embodiment, the first control resource set includes REs other than the characteristic resource subset.

In one embodiment, the characteristic resource subset includes a plurality of REs.

In one embodiment, the number of time-frequency units included in the characteristic resource subset is related to the precoding granularity of the first control resource set.

In one embodiment, the first node of the present application assumes that the same precoding is used in the characteristic resource subset.

In one embodiment, the characteristic resource subset is a pre-coded particle of the first control resource set.

In one embodiment, the characteristic resource subset is a Resource Element Group (REG) bundle.

In one embodiment, the characteristic resource subset is a CCE.

In one embodiment, the characteristic resource subset occupies in frequency domain an RB subset that occupies consecutive RBs in frequency domain included in the first control resource set.

In one embodiment, the characteristic resource subset is a set of REGs that the first node may assume to employ the same precoding.

In one embodiment, the characteristic resource subset is a REG bundle, or, alternatively, the characteristic resource subset occupies in frequency domain an RB subset occupying consecutive RBs in the frequency domain included in the first control resource set.

In one embodiment, the characteristic resource subset is time-frequency resources occupied by a control channel candidate.

In one embodiment, the characteristic resource subset consists of REs occupied by a control channel candidate.

In one embodiment, the characteristic resource subset consists of a REG or REG bundle occupied by a control channel candidate.

In one embodiment, the characteristic resource subset consists of CCEs occupied by a control channel candidate.

In one embodiment, the characteristic resource subset occupies continuous frequency-domain resources and occupies continuous resources in time domain.

In one embodiment, the characteristic resource subset occupies consecutive RBs in frequency domain and consecutive time-domain symbols in time domain.

In one embodiment, time-domain symbols occupied by the characteristic resource subset in time domain are the same as time-domain symbols occupied by the first control resource set in time domain.

In one embodiment, the characteristic resource subset and the first control resource set occupy the same time-domain resources in the time domain.

In one embodiment, the statement in the claims that “the second information block is used to determine a characteristic resource subset” includes the following meaning: the second information block is used by the first node of this application to determine the characteristic resource subset.

In one embodiment, the statement in the claims that “the second information block is used to determine a characteristic resource subset” includes the following meaning: the second information block is used to explicitly or implicitly indicate the characteristic resource subset.

In one embodiment, the statement in the claims that “the second information block is used to determine a characteristic resource subset” includes the following meaning: the second information block is used to explicitly or implicitly indicate RBs included in the characteristic resource subset in frequency domain and time-domain symbols included in the characteristic resource subset in time domain.

In one embodiment, the statement in the claims that “the second information block is used to determine a characteristic resource subset” includes the following meaning: the second information block comprises a bitmap, the bitmap in the second information block being used to explicitly or implicitly indicate the RBs included in the characteristic resource subset in frequency domain; the second information block comprises a duration indication, the duration indication in the second information block being used to explicitly or implicitly indicate the number of time-domain symbols included in the characteristic resource subset in time domain.

In one embodiment, the statement in the claims that “the second information block is used to determine a characteristic resource subset” includes the following meaning: the second information block is used to explicitly or implicitly indicate precoding granularity of the first control resource set, the precoding granularity of the first control resource set being used to determine the characteristic resource subset.

In one embodiment, the statement in the claims that “the second information block is used to determine a characteristic resource subset” includes the following meaning: the second information block is used to explicitly or implicitly indicate precoding granularity of the first control resource set, with the characteristic resource subset being a pre-coded particle of the first control resource set.

In one embodiment, the statement in the claims that “the second information block is used to determine a characteristic resource subset” includes the following meaning: the second information block comprises a bitmap, the bitmap in the second information block being used to explicitly or implicitly indicate the RBs included in frequency domain in the first control resource set; the second information block includes a precoding granularity indication, the precoding granularity indication included in the second information block is used to explicitly or implicitly indicate the precoding granularity of the first control resource set; when the precoding granularity of the first control resource set is REG bundle, the characteristic resource subset is a REG bundle; when the precoding granularity of the first control resource set is continuous RBs, the characteristic resource subset is an RB subset including continuous RBs in frequency domain as indicated by one bitmap included in the second information block.

In one embodiment, the statement in the claims that “the second information block is used to determine a characteristic resource subset” includes the following meaning: the second information block is used to explicitly or implicitly indicate control channel candidates monitored in the first control resource set, the characteristic resource subset being time-frequency resources occupied by one of the control channel candidates monitored in the first control resource set.

In one embodiment, the statement in the claims that “the second information block is used to determine a characteristic resource subset” includes the following meaning: the second information block is used to explicitly or implicitly indicate the first control resource set and control channel candidates monitored in the first control resource set belong to a search space set associated with the first control resource set, the characteristic resource subset being time-frequency resources occupied by one of the control channel candidates monitored in the first control resource set.

In one embodiment, the statement in the claims that “the second information block is used to determine a characteristic resource subset” includes the following meaning: the second information block is used to explicitly or implicitly indicate a search space set associated with the first control resource set and control channel candidates monitored in the first control resource set belong to the search space set associated with the first control resource set, the characteristic resource subset being time-frequency resources occupied by one of the control channel candidates monitored in the first control resource set.

In one embodiment, the statement in the claims that “the second information block is used to determine a characteristic resource subset” includes the following meaning: the second information block is used to explicitly or implicitly indicate the first control resource set, with the characteristic resource subset being a CCE included in the first control resource set.

In one embodiment, the statement in the claims that “the second information block is used to determine a characteristic resource subset” includes the following meaning: the second information block is used to explicitly or implicitly indicate the first control resource set, with the characteristic resource subset being a REG Bundle included in the first control resource set.

In one embodiment, any time-frequency unit included in the characteristic resource subset occupies one RB in frequency domain and one time-domain symbol in time domain.

In one embodiment, any time-frequency unit included in the characteristic resource subset is a REG.

In one embodiment, any time-frequency unit included in the characteristic resource subset is a CCE.

In one embodiment, any time-frequency unit included in the characteristic resource subset is a REG bundle.

In one embodiment, any two time-frequency units included in the characteristic resource subset include the same number of REs.

In one embodiment, the characteristic resource subset includes two time-frequency units including different numbers of REs.

In one embodiment, any time-frequency unit included in the characteristic resource subset includes at least one RE being used for the second-type reference signals.

In one embodiment, the second information block is used to explicitly or implicitly indicate the number of time-frequency units included in the characteristic resource subset.

In one embodiment, two different fields included in the second information block are used to explicitly or implicitly indicate the number of time-frequency units included in the first control resource set and the number of time-frequency units included in the characteristic resource subset, respectively.

In one embodiment, any RE included in any time-frequency unit included in the characteristic resource subset belongs to the first control resource set.

In one embodiment, the statement in the claims that “the characteristic resource subset and the first RE set are in a relationship other than a characteristic relationship” and the statement that “the characteristic resource subset and the first RE set are not in the characteristic relationship” are equivalent or interchangeable.

In one embodiment, the statement in the claims that “the characteristic resource subset and the first RE set are in a relationship other than a characteristic relationship” and the statement that “the first node in the present application expects that the characteristic resource subset and the first RE set are in a relationship other than the characteristic relationship” are equivalent or interchangeable.

In one embodiment, the statement in the claims that “the characteristic resource subset and the first RE set are in a relationship other than a characteristic relationship” and the statement that “the first node in the present application does not expect that the characteristic resource subset and the first RE set are in the characteristic relationship” are equivalent or interchangeable.

In one embodiment, the statement in the claims that “the characteristic resource subset and the first RE set are in a relationship other than a characteristic relationship” and the statement that “the first node in the present application determines that the characteristic resource subset and the first RE set are in a relationship other than a characteristic relationship” are equivalent or interchangeable.

In one embodiment, the statement in the claims that “the characteristic resource subset and the first RE set are in a relationship other than a characteristic relationship” and the statement that “the first node in the present application does not expect that the relationship between the characteristic resource subset and the first RE set is the characteristic relationship” are equivalent or interchangeable.

In one embodiment, when the characteristic relationship is the first relationship, the statement in the claims that “the characteristic resource subset and the first RE set are in a relationship other than a characteristic relationship” and the statement that “the first node in the present application does not expect that there exists at least one overlapping RE between only part of time-frequency units of the characteristic resource subset and the first RE set” are equivalent or interchangeable; when the characteristic relationship is the second relationship, the statement in the claims that “the characteristic resource subset and the first RE set are in a relationship other than a characteristic relationship” and the statement that “the first node in the present application does not expect that there exists any overlapping RE between the characteristic resource subset and the first RE set” are equivalent or interchangeable.

In one embodiment, the characteristic relationship is determined from the first relationship or the second relationship.

In one embodiment, whether the characteristic relationship is the first relationship or the second relationship is configured via signaling.

In one embodiment, whether the characteristic relationship is the first relationship or the second relationship is determined based on a conditional relationship.

In one embodiment, whether the characteristic relationship is the first relationship or the second relationship is determined based on the capability of the first node in this application.

In one embodiment, whether the characteristic relationship is the first relationship or the second relationship is predefined.

In one embodiment, the second information block is used to explicitly or implicitly indicate the characteristic relationship from the first relationship or the second relationship.

In one embodiment, a signaling other than the second information block is used to explicitly or implicitly indicate the characteristic relationship from the first relationship or the second relationship.

In one embodiment, a capability report of the first node is used to explicitly or implicitly determine the characteristic relationship from the first relationship or the second relationship.

In one embodiment, at least one of a network signaling or a capability report of the first node is used to determine the characteristic relationship between the first relationship or the second relationship.

In one embodiment, a capability report of the first node is used together with the second information block to explicitly or implicitly determine the characteristic relationship from the first relationship or the second relationship.

In one embodiment, a capability report of the first node is used together with a signaling other than the second information block to explicitly or implicitly determine the characteristic relationship from the first relationship or the second relationship.

In one embodiment, a capability report of the first node explicitly or implicitly indicates that the capability to support CRS Puncturing PDCCH and the characteristic relationship being the first relationship are equivalent or are used interchangeably.

In one embodiment, a capability report of the first node explicitly or implicitly indicates that the capability to support the presence of at least one overlapping RE between CRS and PDCCH (or CORESET) and the characteristic relationship being the first relationship are equivalent or are used interchangeably.

In one embodiment, a capability report of the first node explicitly or implicitly indicates that the capability not to support CRS Puncturing PDCCH and the characteristic relationship being the second relationship are equivalent or are used interchangeably.

In one embodiment, a capability report of the first node explicitly or implicitly indicates that the capability to support only orthogonality between CRS and PDCCH (or CORESET) and the characteristic relationship being the second relationship are equivalent or are used interchangeably.

In one embodiment, that CRS Puncturing PDCCH is configured or provided or turned on (enabled or on) and the characteristic relationship being the first relationship are equivalent or are used interchangeably.

In one embodiment, that CRS Puncturing PDCCH is not being configured or not being provided or being turned off (disabled or off) and the characteristic relationship being the second relationship are equivalent or are used interchangeably.

In one embodiment, that the presence of at least one overlapping RE between CRS and PDCCH (or CORESET) is configured or provided or turned on (enabled or on) and the characteristic relationship being the first relationship are equivalent or can be used interchangeably.

In one embodiment, that the presence of at least one overlapping RE between CRS and PDCCH (or CORESET) is not configured or is not provided or is turned off (disabled or off) and the characteristic relationship being the second relationship are equivalent or are used interchangeably.

In one embodiment, that supporting overlapping REs between the first RE set and the first control resource set is configured or provided or turned on (enabled or on) and the characteristic relationship being the first relationship are equivalent or are used interchangeably.

In one embodiment, that supporting overlapping REs between the first RE set and the first control resource set is not being configured or not being provided or is turned off (disabled or off) and the characteristic relationship being the second relationship are equivalent or are used interchangeably.

In one embodiment, that no overlapping REs are supported between the first RE set and the first control resource set and the characteristic relationship being the second relationship are equivalent or are used interchangeably.

In one embodiment, the CRS Punctured PDCCH, the presence of at least one overlapping RE between CRS and PDCCH (or CORESET), the non-orthogonality of the first RE set and the first control resource set, and the presence of at least one overlapping RE between the first RE set and the first control resource set are equivalent or are used interchangeably.

In one embodiment, when a capability report of the first node is used to explicitly or implicitly indicate a first capability, a characteristic signaling is used to explicitly or implicitly indicate the characteristic relationship from the first relationship or the second relationship; when a capability report of the first node explicitly or implicitly indicates a second capability, the characteristic relationship is the second relationship; the first capability and the second capability are different capabilities. In one subsidiary embodiment of the above embodiment, the first capability is a capability that supports CRS Puncturing PDCCH while the second capability is a capability that does not support CRS Puncturing PDCCH. In one subsidiary embodiment of the above embodiment, the first capability is a capability to support the presence of at least one overlapping RE between CRS and PDCCH (or CORESET), and the second capability is a capability to not support the presence of any overlapping RE between the CRS and the PDCCH (CORESET). In one subsidiary embodiment of the above embodiment, the first capability is a capability that supports the presence of at least one overlapping RE between CRS and PDCCH (or CORESET), and the second capability is a capability that supports only the orthogonality of the CRS and the PDCCH (CORESET). In one subsidiary embodiment of the above embodiment, the first capability is a capability that supports the presence of at least one overlapping RE between CRS and PDCCH (or CORESET) and orthogonality between the CRS and PDCCH, and the second capability is a capability that supports orthogonality between the CRS and the PDCCH (CORESET) only. In one subsidiary embodiment of the above embodiment, the first capability and the second capability are capabilities for two types of channel estimation. In one subsidiary embodiment of the above embodiment, the first capability is a capability that supports the presence of at least one overlapping RE between the first RE set and the first control resource set, and the second capability is a capability that does not support the presence of any overlapping RE between the first RE set and the first control resource set. In one subsidiary embodiment of the above embodiment, the characteristic signaling comprises all or part of fields included in the second information block. In one subsidiary embodiment of the above embodiment, the characteristic signaling and the second information block are different fields belonging to the same IE. In one subsidiary embodiment of the above embodiment, the characteristic signaling and the second information block are two different signalings.

In one embodiment, an index of the first control resource set is used to determine the characteristic relationship between the first relationship or the second relationship.

In one embodiment, the statement in the claims that “the first relationship includes that there exists at least one overlapping RE between only part of time-frequency units of the characteristic resource subset and the first RE set” means that the first relationship and “there exists at least one overlapping RE between only part of time-frequency units of the characteristic resource subset and the first RE set” are equivalent or can be used interchangeably.

In one embodiment, the statement in the claims that “the first relationship includes that there exists at least one overlapping RE between only part of time-frequency units of the characteristic resource subset and the first RE set” means that the first relationship is that there exists at least one overlapping RE between only part of time-frequency units of the characteristic resource subset and the first RE set.

In one embodiment, the statement in the claims that “the first relationship includes that there exists at least one overlapping RE between only part of time-frequency units of the characteristic resource subset and the first RE set” means that the first relationship and “there exists at least one overlapping RE between a first time-frequency unit of the characteristic resource subset and the first RE set, and there doesn't exist any overlapping RE between a second time-frequency unit of the characteristic resource subset and the first RE set, the first time-frequency unit and the second time-frequency unit being two different time-frequency units belonging to the characteristic resource subset” are equivalent or can be used interchangeably.

In one embodiment, the statement in the claims that “the first relationship includes that there exists at least one overlapping RE between only part of time-frequency units of the characteristic resource subset and the first RE set” means that the first relationship and “Neither between the characteristic resource subset and the first RE set is there at least one overlapping RE between each time-frequency unit and the first RE, nor is there orthogonality between the characteristic resource subset and the first RE set” are equivalent or can be used interchangeably.

In one embodiment, the statement in the claims that “the first relationship includes that there exists at least one overlapping RE between only part of time-frequency units of the characteristic resource subset and the first RE set” means that the first relationship and “there is no orthogonality between the characteristic resource subset and the first RE set but the characteristic resource subset includes a time-frequency unit being orthogonal to the first RE” are equivalent or can be used interchangeably.

In one embodiment, the statement in the claims that “the first relationship includes that there exists at least one overlapping RE between only part of time-frequency units of the characteristic resource subset and the first RE set” means that the first relationship and “there is at least one overlapping RE between the characteristic resource subset and the first RE set but the characteristic resource subset includes a time-frequency unit having no RE overlapping with the first RE” are equivalent or can be used interchangeably.

In one embodiment, the statement in the claims that “the first relationship includes that there exists at least one overlapping RE between only part of time-frequency units of the characteristic resource subset and the first RE set” means that the first relationship and “there is at least one overlapping RE between the characteristic resource subset and the first RE set but the characteristic resource subset includes a time-frequency unit having no RE overlapping with the first RE” are equivalent or can be used interchangeably.

In one embodiment, the statement in the claims that “the second relationship includes that there exists at least one overlapping RE between the characteristic resource subset and the first RE set” means that the second relationship and “there exists at least one overlapping RE between the characteristic resource subset and the first RE set” are equivalent or can be used interchangeably.

In one embodiment, the statement in the claims that “the second relationship includes that there exists at least one overlapping RE between the characteristic resource subset and the first RE set” means that the second relationship is that there exists at least one overlapping RE between the characteristic resource subset and the first RE set.

In one embodiment, the statement in the claims that “the second relationship includes that there exists at least one overlapping RE between the characteristic resource subset and the first RE set” means that the second relationship and “there is no orthogonality between the characteristic resource subset and the first RE set” are equivalent or can be used interchangeably.

In one embodiment, the statement in the claims that “the second relationship includes that there exists at least one overlapping RE between the characteristic resource subset and the first RE set” means that the second relationship and “the characteristic resource subset at least includes one time-frequency unit having at least one RE overlapping with the first RE set” are equivalent or can be used interchangeably.

In one embodiment, the statement in the claims that “the second relationship includes that there exists at least one overlapping RE between the characteristic resource subset and the first RE set” means that the second relationship and “there is at least one RE belonging to both the characteristic resource subset and the first RE set” are equivalent or can be used interchangeably.

In one embodiment, the statement in the claims that “the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set” includes the following meaning: the first node of the present application does not expect that there exists overlapping RE between only a portion of the time-frequency units included in the characteristic resource subset and the first RE set, or the first node of the present application does not expect that there is any overlapping REs between the characteristic resource subset and the first RE set.

In one embodiment, the statement in the claims that “the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set” includes the following meaning: the first node of the present application expects that either there is orthogonality between the characteristic resource subset and the first RE set, or there is at least one overlapping RE between each time-frequency unit included in the characteristic resource subset and the first RE set.

In one embodiment, the statement in the claims that “the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set” includes the following meaning: when the characteristic relationship is the first relationship, the first node of the present application does not expect that there exists at least one overlapping RE between only a portion of the time-frequency units in the characteristic resource subset and the first RE set; when the characteristic relationship is the second relationship, the first node of the present application does not expect that there is any overlapping REs between the characteristic resource subset and the first RE set.

In one embodiment, the statement in the claims that “the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set” includes the following meaning: when a capability report of the first node indicates, either explicitly or implicitly, the capability to support presence of overlapping RE(s) between CORESET (or PDCCH) and the first-type reference signals, the first node of the present application does not expect that there exists at least one overlapping RE between only a portion of the time-frequency units in the characteristic resource subset and the first RE set; otherwise, the first node of the present application does not expect that there is any overlapping REs between the characteristic resource subset and the first RE set.

In one embodiment, the statement in the claims that “the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set” includes the following meaning: when a capability report of the first node indicates, either explicitly or implicitly, the capability to support the first-type reference signals in puncturing or occupying REs of CORESET (or PDCCH), the first node of the present application does not expect that there exists at least one overlapping RE between only a portion of the time-frequency units in the characteristic resource subset and the first RE set; otherwise, the first node of the present application does not expect that there is any overlapping REs between the characteristic resource subset and the first RE set.

In one embodiment, the statement in the claims that “the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set” includes the following meaning: when a capability report of the first node indicates, either explicitly or implicitly, the capability to support presence of overlapping RE(s) between CORESET (or PDCCH) and the first-type reference signals, and when the signaling configures that the presence of overlapping RE(s) between CORESET (or PDCCH) and the first-type reference signals is turned on (enabled), the first node of the present application does not expect that there exists at least one overlapping RE between only a portion of the time-frequency units in the characteristic resource subset and the first RE set; otherwise, the first node of the present application does not expect that there is any overlapping REs between the characteristic resource subset and the first RE set.

In one embodiment, the statement in the claims that “the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set” includes the following meaning: when a capability report of the first node indicates, either explicitly or implicitly, the capability to support the first-type reference signals in puncturing or occupying REs of CORESET (or PDCCH), and when the signaling configures that the first-type reference signals puncturing or occupying REs of CORESET (or PDCCH) is turned on (enabled), the first node of the present application does not expect that there exists at least one overlapping RE between only a portion of the time-frequency units in the characteristic resource subset and the first RE set; otherwise, the first node of the present application does not expect that there is any overlapping REs between the characteristic resource subset and the first RE set.

In one embodiment, there are overlapping REs between the first control resource set and the first RE set.

In one embodiment, there is no overlapping RE between the first control resource set and the first RE set.

In one embodiment, the first control resource set and the first RE set are non-orthogonal.

In one embodiment, the first control resource set and the first RE set are orthogonal.

In one embodiment, there being overlapping RE(s) between the first control resource set and the first RE set and the first control resource set comprising REs punctured by the first-type reference signals are equivalent or used interchangeably.

In one embodiment, there being overlapping RE(s) between the first control resource set and the first RE set and a PDCCH being punctured by LTE CRS are equivalent or used interchangeably.

In one embodiment, allowing the presence of overlapping RE(s) between the first control resource set and the first RE set and allowing a signaling-configured PDCCH to be punctured by LTE CRS are equivalent or used interchangeably.

### Embodiment 2

Embodiment 2 illustrates a schematic diagram of a network architecture according to the present application, as shown in FIG. 2. FIG. 2 is a diagram illustrating a network architecture 200 of 5G NR, Long-Term Evolution (LTE) and Long-Term Evolution Advanced (LTE-A) systems. The 5G NR or LTE network architecture 200 may be called a 5G System/Evolved Packet System (5GS/EPS) 200 or other suitable terminology. The 5GS/EPS 200 may comprise one or more UEs 201, an NG-RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR/evolved node B (gNB/eNB) 203 and other gNB(eNB) 204. The gNB(eNB)203 provides UE 201 oriented user plane and control plane terminations. The gNB(eNB)203 can be connected to other gNB(eNB) 204 via an Xn/X2 interface (like backhaul). The gNB(eNB)203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB(eNB)203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB(eNB)203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the gNB(eNB) 203 corresponds to the second node in the present application.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 used for a first node (UE or gNB) and a second node (gNB or UE) is represented by three layers, which are layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first node between second nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service DataAdaptation Protocol (SDAP) sublayer 356, which is in charge of the mapping between QoS streams and a Data Radio Bearer (DRB), so as to support diversified traffics. Although not described in FIG. 3, the first node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first information block in the present application is generated by the RRC306, or the MAC302, or the MAC352, or by the PHY301, or the PHY351.

In one embodiment, the second information block in the present application is generated by the RRC306, or the MAC302, or the MAC352, or by the PHY301, or the PHY351.

In one embodiment, the control signaling candidate in the present application is generated by the RRC306, or the MAC302, or the MAC352, or by the PHY301, or the PHY351.

In one embodiment, the third information block in the present application is generated by the RRC306, or the MAC302, or the MAC352, or by the PHY301, or the PHY351.

In one embodiment, the fourth information block in the present application is generated by the RRC306, or the MAC302, or the MAC352, or by the PHY301, or the PHY351.

### Embodiment 4

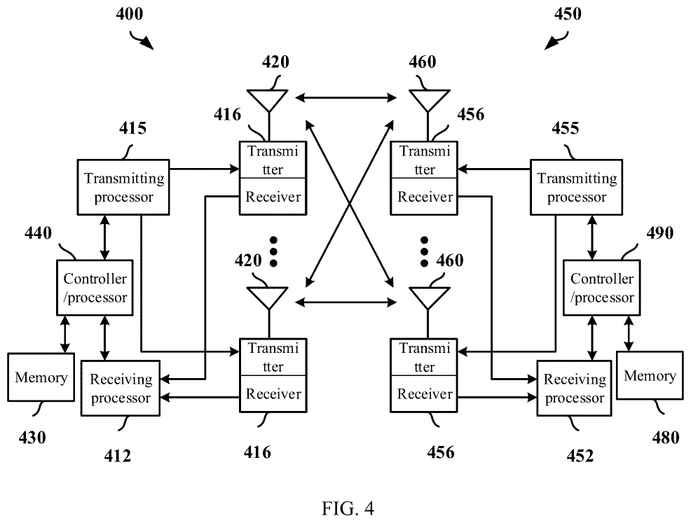

Embodiment 4 illustrates a schematic diagram of a first node and a second node according to one embodiment of the present application, as shown in FIG. 4.

The first node (450) can comprise a controller/processor 490, a data source/buffer 480, a receiving processor 452, a transmitter/receiver 456 and a transmitting processor 455, where the transmitter/receiver 456 comprises an antenna 460.

The second node (410) can comprise a controller/processor 440, a data source/buffer 430, a receiving processor 412, a transmitter/receiver 416 and a transmitting processor 415, where the transmitter/receiver 416 comprises an antenna 420.

In Downlink (DL), a higher layer packet, for instance higher-layer information contained in the first information block, the second information block and the fourth information block in the present application is provided to the controller/processor 440. The controller/processor 440 provides functions of the L2 layer and above. In DL, the controller/processor 440 provides header compression, encryption, packet segmentation and reordering, multiplexing between a logical channel and a transport channel as well as radio resources allocation for the first node 450 based on various priorities. The controller/processor 440 is also responsible for HARQ operation, a retransmission of a lost packet and a signaling to the first node 450, for instance, higher-layer information carried in the first information block, the second information block and the fourth information block is generated in the controller/processor 440. The transmitting processor 415 performs various signal processing functions used for the L1 (that is, PHY), including coding, interleaving, scrambling, modulating, power control/allocating, pre-coding and physical layer control signaling generation, for example, the generations of physical-layer signals of the first information block, the second information block and the fourth information block in the present application and of physical-layer signals of the control channel candidates in the present application are completed in the transmitting processor 415. Modulation symbols that have been generated are divided into parallel streams and each of them is mapped onto a corresponding multicarrier subcarrier and/or multicarrier symbol, and then is mapped by the transmitting processor 415 to the antenna 420 via the transmitter 416 to be transmitted in the form of radio frequency signals. At the receiving end, each receiver 456 receives a radio frequency signal via a corresponding antenna 460, and recovers baseband information modulated onto a radio frequency carrier and provides the baseband information to the receiving processor 452. The receiving processor 452 performs various signal receiving processing functions used for the L1. Signal receiving processing functions include receiving physical layer signals of the first information block, the second information block and the fourth information block in the present application and receiving physical layer signals of the control channel candidates, and demodulating multicarrier symbols in multicarrier symbol streams based on various modulation schemes (i.e., BPSK, QPSK), then de-scrambling, decoding and de-interleaving to recover data or control signal transmitted by the second node 410 on a physical channel, and providing the data and control signal to the controller/processor 490. The controller/processor 490 is in charge of the L2 and above layers, the controller/processor 490 interprets higher-layer information comprised in the first information block, the second information block and the fourth information block in the present application. The controller/processor can be associated with the memory 480 that stores program code and data; the memory 480 may be called a computer readable medium.

In UL transmission, which is similar to DL, higher-layer information, including that contained in the third information block in the present application, upon generation in the controller/processor 490, is through the transmitting processor 455 to perform signal transmitting processing functions used for the L1 (that is, PHY), for instance, generation of physical layer signals carrying the third information block in the present application is completed in the transmitting processor 455, and are then mapped to the antenna 460 via the transmitter 456 from the transmitting processor 455 and transmitted in the form of radio frequency signals. The receiver 416 receives a radio frequency signal via a corresponding antenna 420, and each receiver 416 recovers baseband information modulated onto a radio frequency carrier and provides the baseband information to the receiving processor 412. The receiving processor 412 performs various signal reception processing functions used for L1 (i.e., PHY), including receiving a physical layer signal carrying the third information block in the present application and then providing data and/or control signal to the controller/processor 440. Functions of the L2 performed by the controller/processor 440 include interpreting higher-layer information, including interpreting higher-layer information carried in the third information block in the present application. The controller/processor can be associated with the buffer 430 that stores program code and data; the buffer 430 may be called a computer readable medium.

In one embodiment, the first node 450 comprises at least one processor and at least one memory. The at least one memory comprises computer program codes; the at least one memory and the computer program codes are configured to be used in collaboration with the at least one processor. The first node 450 at least receives a first information block and receives a second information block, the first information block being used to determine a first RE set, the first RE set comprising at least one RE, and any RE in the first RE set being used for first-type reference signals; and monitors control channel candidates in a first control resource set, the first control resource set comprising multiple REs, and the first control resource set comprising at least one RE being used for second-type reference signals, the second-type reference signals and the first-type reference signals being two different types of reference signals, the second-type reference signals being used for demodulation of control channels; herein, the second information block is used to determine a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set.

In one embodiment, the first node 450 comprises a memory that stores a computer readable instruction program. The computer readable instruction program generates actions when executed by at least one processor. The actions include: receiving a first information block and receiving a second information block, the first information block being used to determine a first RE set, the first RE set comprising at least one RE, and any RE in the first RE set being used for first-type reference signals; and monitoring control channel candidates in a first control resource set, the first control resource set comprising multiple REs, and the first control resource set comprising at least one RE being used for second-type reference signals, the second-type reference signals and the first-type reference signals being two different types of reference signals, the second-type reference signals being used for demodulation of control channels; herein, the second information block is used to determine a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set.

In one embodiment, the second node 410 comprises at least one processor and at least one memory. The at least one memory comprises computer program codes; the at least one memory and the computer program codes are configured to be used in collaboration with the at least one processor. The second node 410 at least transmits a first information block and transmits a second information block, the first information block being used to indicate a first RE set, the first RE set comprising at least one RE, and any RE in the first RE set being used for first-type reference signals; and transmits control channel candidates in a first control resource set, the first control resource set comprising multiple REs, and the first control resource set comprising at least one RE being used for second-type reference signals, the second-type reference signals and the first-type reference signals being two different types of reference signals, the second-type reference signals being used for demodulation of control channels; herein, the second information block is used to indicate a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set.

In one embodiment, the second node 410 comprises a memory that stores a computer readable instruction program. The computer readable instruction program generates actions when executed by at least one processor. The actions include: transmitting a first information block and transmitting a second information block, the first information block being used to indicate a first RE set, the first RE set comprising at least one RE, and any RE in the first RE set being used for first-type reference signals; and transmitting control channel candidates in a first control resource set, the first control resource set comprising multiple REs, and the first control resource set comprising at least one RE being used for second-type reference signals, the second-type reference signals and the first-type reference signals being two different types of reference signals, the second-type reference signals being used for demodulation of control channels; herein, the second information block is used to indicate a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set.

In one embodiment, the first node 450 is a UE.

In one embodiment, the second node 410 is a base station (gNB/eNB).

In one embodiment, the receiver 456 (comprising the antenna 460), the receiving processor 452 and the controller/processor 490 are used for receiving the first information block in the present application.

In one embodiment, the receiver 456 (comprising the antenna 460), the receiving processor 452 and the controller/processor 490 are used for receiving the second information block in the present application.

In one embodiment, the receiver 456 (comprising the antenna 460), the receiving processor 452 and the controller/processor 490 are used for monitoring control channel candidates in the first control resource set in the present application.

In one embodiment, the transmitter 456 (comprising the antenna 460), the transmitting processor 455 and the controller/processor 490 are used for transmitting the third information block in the present application.

In one embodiment, the receiver 456 (comprising the antenna 460), the receiving processor 452 and the controller/processor 490 are used for receiving the fourth information block in the present application.

In one embodiment, the transmitter 416 (comprising the antenna 420), the transmitting processor 415 and the controller/processor 440 are used for transmitting the first information block in the present application.

In one embodiment, the transmitter 416 (comprising the antenna 420), the transmitting processor 415 and the controller/processor 440 are used for transmitting the second information block in the present application.

In one embodiment, the transmitter 416 (comprising the antenna 420), the transmitting processor 415 and the controller/processor 440 are used for transmitting control channel candidates in the first control resource set in the present application.

In one embodiment, the receiver 416 (comprising the antenna 420), the receiving processor 412 and the controller/processor 440 are used for receiving the third information block in the present application.

In one embodiment, the transmitter 416 (comprising the antenna 420), the transmitting processor 415 and the controller/processor 440 are used for transmitting the fourth information block in the present application.

### Embodiment 5

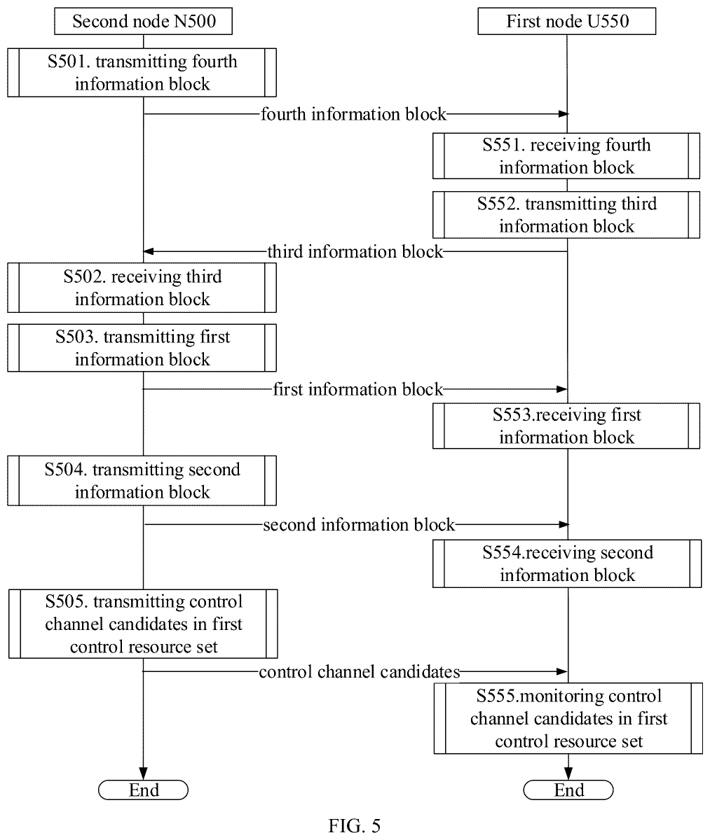

Embodiment 5 illustrates a flowchart of radio signal transmission according to one embodiment of the present application, as shown in FIG. 5. In FIG. 5, a second node N500 is a maintenance base station for a serving cell for a first node U550. It should be particularly noted that the sequence illustrated herein does not set any limit to the signal transmission order or implementation order in the present application.

The second node N500 transmits a fourth information block in step S501, and receives a third information block in step S502, and transmits a first information block in step S503, and transmits a second information block in step S504, and transmits control channel candidates in a first control resource set in step S505.

The first node U550 receives the fourth information block in step S551, and transmits the third information block in step S552, and receives the first information block in step S553, and receives the second information block in step S554, and monitors control channel candidates in the first control resource set in step S555.

In Embodiment 5, the first information block is used to determine a first RE set, the first RE set comprising at least one RE, and any RE in the first RE set being used for first-type reference signals; the first control resource set comprises multiple REs, and the first control resource set comprising at least one RE being used for second-type reference signals, the second-type reference signals and the first-type reference signals being two different types of reference signals, the second-type reference signals being used for demodulation of control channels; herein, the second information block is used to determine a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set; the third information block is used to indicate a capability of the first node; a first quantity value is equal to a number of time-domain symbols occupied in time domain by the first control resource set, and a number of time-domain symbols occupied in time domain by the characteristic resource subset is equal to the first quantity value; the fourth information block is used to determine a target quantity set, the target quantity set including multiple quantity values, and the second information block is used to determine the first quantity value out of the target quantity set.

In one embodiment, the third information block is transmitted via an air interface or a wireless interface.

In one embodiment, the third information block comprises all or part of a higher layer signaling or a physical layer signaling.

In one embodiment, the third information block comprises all or part of a Radio Resource Control (RRC) layer signaling or a Medium Access Control (MAC) layer signaling.

In one embodiment, the third information block comprises all or part of fields in an Uplink Control Information (UCI) Format.

In one embodiment, the third information block comprises all or part of a field “pdcch-lteCRSPuncturing” in an RRC layer signaling.

In one embodiment, the third information block comprises all or part of fields in an Information Element (IE) “FeatureSetDownlink” in an RRC layer signaling.

In one embodiment, the third information block comprises all or part of fields in an Information Element (IE) “FeatureSetDownlinkPerCC” in an RRC layer signaling.

In one embodiment, the third information block comprises all or part of fields in an Information Element (IE) “BandCombinationList” in an RRC layer signaling.

In one embodiment, the third information block comprises all or part of fields in an Information Element (IE) “BandNR” in an RRC layer signaling.

In one embodiment, the third information block comprises capability indication information.

In one embodiment, the statement in the claims that “the third information block is used to indicate a capability of the first node” includes the following meaning: the third information block is used to explicitly or implicitly indicate the capability of the first node.

In one embodiment, the statement in the claims that “the third information block is used to indicate a capability of the first node” includes the following meaning: the third information block is used by the first node in the present application to indicate the capability of the first node.

In one embodiment, the statement in the claims that “the third information block is used to indicate a capability of the first node” includes the following meaning: the third information block is used to indicate all or part of the capability of the first node.

In one embodiment, the statement in the claims that “the third information block is used to indicate a capability of the first node” includes the following meaning: the third information block is used to indicate all or part of the capability of the first node with respect to the PDCCH.

In one embodiment, the statement in the claims that “the third information block is used to indicate a capability of the first node” includes the following meaning: the third information block is used to indicate whether the first node supports the capability of monitoring a PDCCH that is punctured by a CRS.

In one embodiment, the statement in the claims that “the third information block is used to indicate a capability of the first node” includes the following meaning: the third information block is used to indicate whether the first node supports the capability of having at least one overlapping RE between the first control resource set and the first RE set.

In one embodiment, the statement in the claims that “the third information block is used to indicate a capability of the first node” includes the following meaning: the third information block is used to indicate whether the first node supports the capability of having at least one overlapping RE between a CORESET and the first-type reference signals.

In one embodiment, the third information block is before the first information block.

In one embodiment, the third information block is after the first information block.

In one embodiment, the third information block is before the second information block.

In one embodiment, the third information block is after the second information block.

In one embodiment, the fourth information block is transmitted via an air interface or a wireless interface.

In one embodiment, the fourth information block comprises all or part of a higher layer signaling or a physical layer signaling.

In one embodiment, the fourth information block comprises all or part of a Radio Resource Control (RRC) layer signaling or a Medium Access Control (MAC) layer signaling.

In one embodiment, the fourth information block comprises all or part of a Master Information Block (MIB).

In one embodiment, the fourth information block is carried via an SSB.

In one embodiment, the fourth information block comprises all or part of a System Information Block (SIB).

In one embodiment, the fourth information block comprises all or part of a SIB1.

In one embodiment, the fourth information block is Cell Specific.

In one embodiment, the fourth information block is Per Bandwidth-Part (BWP) Configured.

In one embodiment, the fourth information block comprises all or part of fields in a DCI Format.

In one embodiment, the fourth information block comprises all or part of afield “dmrs-TypeA-Position” in an RRC layer signaling.

In one embodiment, the fourth information block comprises all or part of a field “sCellConfigCommon” in an RRC layer signaling.

In one embodiment, the fourth information block comprises all or part of a field “spCellConfigCommon” in an RRC layer signaling.

In one embodiment, the fourth information block comprises all or part of fields in an Information Element (IE) “ServingCellConfigCommon” in an RRC layer signaling.

In one embodiment, the fourth information block comprises all or part of fields in an Information Element (IE) “ServingCellConfigCommonSIB” in an RRC layer signaling.

In one embodiment, the fourth information block is before the first information block.

In one embodiment, the fourth information block is after the first information block.

In one embodiment, the fourth information block and the first information block are transmitted through a same physical channel.

In one embodiment, the fourth information block and the first information block belong to two different fields in a same IE.

In one embodiment, the fourth information block and the first information block belong to two different IEs.

In one embodiment, the fourth information block is before the second information block.

In one embodiment, the fourth information block is after the second information block.

In one embodiment, the fourth information block and the second information block are transmitted through a same physical channel.

In one embodiment, the fourth information block and the second information block belong to two different fields in a same IE.

In one embodiment, the fourth information block and the second information block belong to two different IEs.

In one embodiment, the fourth information block is before the third information block.

In one embodiment, the fourth information block is after the third information block.

In one embodiment, the statement in the claims that “the fourth information block is used to determine a target quantity set” includes the following meaning: the fourth information block is used by the first node in the present application to determine the target quantity set.

In one embodiment, the statement in the claims that “the fourth information block is used to determine a target quantity set” includes the following meaning: the fourth information block is used to explicitly or implicitly indicate the target quantity set.

In one embodiment, the statement in the claims that “the fourth information block is used to determine a target quantity set” includes the following meaning: the fourth information block is used to indicate, explicitly or implicitly, a maximum quantity value included in the target quantity set, the target quantity set consisting of positive integers no greater than the maximum quantity value.

In one embodiment, the statement in the claims that “the fourth information block is used to determine a target quantity set” includes the following meaning: the fourth information block is used to explicitly or implicitly indicate a time domain start position of a DMRS, the time domain start position of the DMRS being used to determine the target quantity set.

In one embodiment, the statement in the claims that “the fourth information block is used to determine a target quantity set” includes the following meaning: the fourth information block is used to explicitly or implicitly indicate a time domain start position of a DMRS, the time domain start position of the DMRS indicated by the fourth information block being used to determine a maximum quantity value included in the target quantity set, the target quantity set consisting of positive integers no greater than the maximum quantity value.

In one embodiment, the statement in the claims that “the fourth information block is used to determine a target quantity set” includes the following meaning: the fourth information block is used to explicitly or implicitly indicate a time domain start position of a DMRS, the time domain start position of the DMRS indicated by the fourth information block being used to determine whether at least one quantity value belongs to the target quantity set.

### Embodiment 6

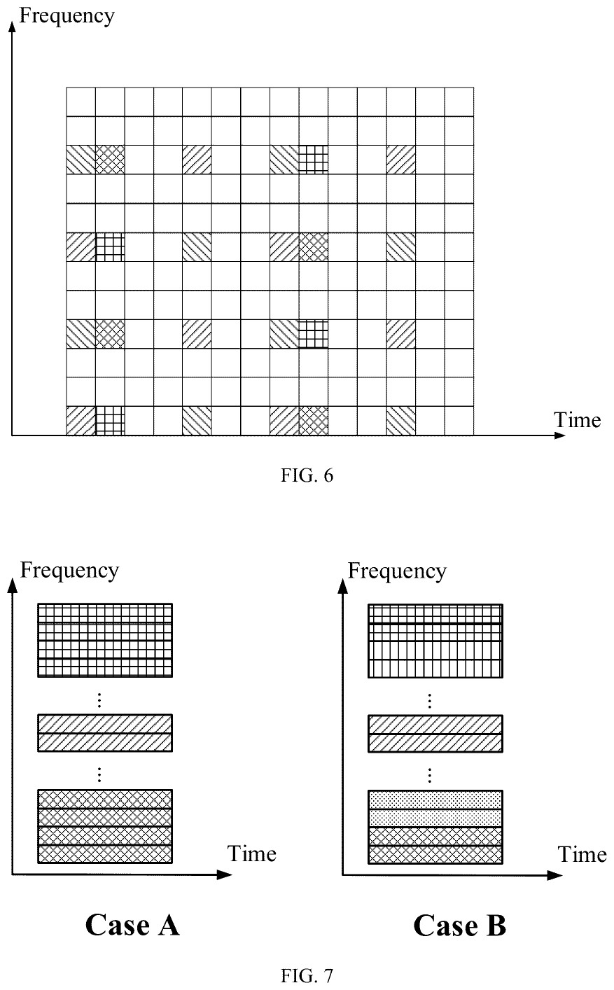

Embodiment 6 illustrates a schematic diagram of first-type reference signals according to one embodiment of the present application, as shown in FIG. 6. In FIG. 6, the horizontal axis represents time and the vertical axis represents frequency, each small square represents an RE, and each filled square represents an RE occupied by first-type reference signals, a square with a different filling denoting a different antenna port of the first-type reference signals.

In Embodiment 6, the first information block in this application comprises a first sub-information-block and a second sub-information-block, the first sub-information-block being used to determine a number of antenna ports of the first-type reference signals in this application, the second sub-information-block being used to determine a frequency-domain location of REs comprised by the first RE set in this application, and at least one of the number of the antenna ports of the first-type reference signals or the frequency-domain location of the REs comprised by the first RE set being used to determine the characteristic relationship in this application between the first relationship or the second relationship in this application.

In one embodiment, the first sub-information-block and the second sub-information-block are two different fields in a same IE.

In one embodiment, the first sub-information-block and the second sub-information-block are two different IEs.

In one embodiment, the first sub-information-block and the second sub-information-block are two different fields included in the first information block.

In one embodiment, the statement “the first sub-information-block being used to determine a number of antenna ports of the first-type reference signals” in the claims includes the following meaning: the first sub-information-block is used by the first node in the present application to determine the number of antenna ports of the first-type reference signals.

In one embodiment, the statement “the first sub-information-block being used to determine a number of antenna ports of the first-type reference signals” in the claims includes the following meaning: the first sub-information-block is used to explicitly or implicitly indicate the number of antenna ports of the first-type reference signals.

In one embodiment, the statement “the first sub-information-block being used to determine a number of antenna ports of the first-type reference signals” in the claims includes the following meaning: the first sub-information-block is used to explicitly or implicitly indicate the number of antenna ports of the first-type reference signals at the time of rate matching or puncturing.

In one embodiment, the statement “the second sub-information-block being used to determine a frequency-domain location of REs comprised by the first RE set” in the claims includes the following meaning: the second sub-information-block is used by the first node of the present application to determine the frequency-domain location of the REs included in the first RE set.

In one embodiment, the statement “the second sub-information-block being used to determine a frequency-domain location of REs comprised by the first RE set” in the claims includes the following meaning: the second sub-information-block explicitly or implicitly indicates the frequency-domain location of the REs included in the first RE set.

In one embodiment, the statement “the second sub-information-block being used to determine a frequency-domain location of REs comprised by the first RE set” in the claims includes the following meaning: the second sub-information-block explicitly or implicitly indicates a frequency-domain location of each RE included in the first RE set in an RB to which the RE belongs.

In one embodiment, the statement “the second sub-information-block being used to determine a frequency-domain location of REs comprised by the first RE set” in the claims includes the following meaning: the second sub-information-block explicitly or implicitly indicates a v-shift of the first-type reference signals, and the v-shift of the first-type reference signals is used to determine the frequency-domain location of the REs included in the first RE set.

In one embodiment, the statement “the second sub-information-block being used to determine a frequency-domain location of REs comprised by the first RE set” in the claims includes the following meaning: the second sub-information-block explicitly or implicitly indicates a frequency-domain location of a carrier to which the first RE set belongs in frequency domain.

In one embodiment, the statement “the second sub-information-block being used to determine a frequency-domain location of REs comprised by the first RE set” in the claims includes the following meaning: the second sub-information-block explicitly or implicitly indicates a bandwidth of a carrier to which the first RE set belongs in frequency domain, and the bandwidth of the carrier to which the first RE set belongs in frequency domain is used to determine the frequency-domain location of the REs included in the first RE set.

In one embodiment, the number of antenna ports of the first-type reference signals is equal to one of 1, 2, or 4.

In one embodiment, the number of antenna ports of the first-type reference signals is equal to 4.

In one embodiment, the number of antenna ports of the first-type reference signals is equal to one of 2 or 4.

In one embodiment, the number of antenna ports of the first-type reference signals is a positive integer.

In one embodiment, the frequency-domain location of REs included in the first RE set refers to a frequency-domain location of each RE included in the first RE set in an RB to which the RE belongs in frequency domain.

In one embodiment, the frequency-domain location of REs included in the first RE set refers to a center frequency of a carrier to which the first RE set belongs in frequency domain.

In one embodiment, the frequency-domain location of REs included in the first RE set refers to the value of a v-shift of the first-type reference signals.

In one embodiment, the frequency-domain location of REs included in the first RE set refers to the distribution of the REs included in the first RE set in frequency domain.

In one embodiment, the statement in the claims that “at least one of the number of the antenna ports of the first-type reference signals or the frequency-domain location of the REs comprised by the first RE set being used to determine the characteristic relationship between the first relationship or the second relationship” includes the following meaning: at least one of the number of the antenna ports of the first-type reference signals or the frequency-domain location of the REs comprised by the first RE set is used by the first node in the present application to determine the characteristic relationship from the first relationship or the second relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that the number of the antenna ports of the first-type reference signals is used to determine the characteristic relationship between the first relationship or the second relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that the frequency-domain location of the REs in the first RE set is used to determine the characteristic relationship between the first relationship or the second relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that both the number of the antenna ports of the first-type reference signals and the frequency-domain location of the REs in the first RE set are used to determine the characteristic relationship from the first relationship or the second relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that whether the number of the antenna ports of the first-type reference signals is equal to 4 is used to determine the characteristic relationship between the first relationship or the second relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that whether the number of the antenna ports of the first-type reference signals is equal to one of 2 or 4 is used to determine the characteristic relationship between the first relationship or the second relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that when the number of the antenna ports of the first-type reference signals is equal to 4, the characteristic relationship is the first relationship; otherwise, the characteristic relationship is the second relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that when the number of the antenna ports of the first-type reference signals is equal to 2 or 4, the characteristic relationship is the first relationship; otherwise, the characteristic relationship is the second relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that when the number of the antenna ports of the first-type reference signals is equal to 4, the characteristic relationship is one of the first relationship or the second relationship; otherwise, the characteristic relationship is the second relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that when the number of the antenna ports of the first-type reference signals is equal to 4, at least one of network signaling or a capability report of the first node is used to determine the characteristic relationship between the first relationship or the second relationship; otherwise, the characteristic relationship is the second relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that when the number of the antenna ports of the first-type reference signals is equal to 2 or 4, the characteristic relationship is one of the first relationship or the second relationship; otherwise, the characteristic relationship is the second relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that when the number of the antenna ports of the first-type reference signals is equal to 2 or 4, at least one of network signaling or a capability report of the first node is used to determine the characteristic relationship between the first relationship or the second relationship; otherwise, the characteristic relationship is the second relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that when there is at least one overlapping RE between the first RE set and the REs occupied by the second-type reference signals, the characteristic relationship is the first relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that at least one of the number of the antenna ports of the first-type reference signals or the frequency-domain location of the REs comprised by the first RE set is used to determine that the characteristic relationship is one of the first relationship or the second relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that whether there is at least one overlapping RE between the first RE set and the REs occupied by the second-type reference signals is used to determine whether the characteristic relationship is the first relationship.

In one embodiment, the statement in the claims that “at least one of the number of the antenna ports of the first-type reference signals or the frequency-domain location of the REs comprised by the first RE set being used to determine the characteristic relationship between the first relationship or the second relationship” means that when there is at least one overlapping RE between the first RE set and the REs occupied by the second-type reference signals, at least one of network signaling or a capability report of the first node is used to determine the characteristic relationship between the first relationship or the second relationship.

### Embodiment 7

Embodiment 7 illustrates a schematic diagram of the precoding granularity of a first control resource set according to one embodiment of the present application, as shown in FIG. 7. In FIG. 7, as shown in Case A and Case B, the horizontal axis represents time, the vertical axis represents frequency, and each filled rectangular box represents an RB occupied by a first control resource set in the frequency domain, and rectangles with the same filling have the same precoding; in Case A, the precoding granularity of the first control resource set is all contiguous RBs; in Case B, the precoding granularity of the first control resource set is the REG bundle.

In Embodiment 7, the second information block in the present application is used to determine precoding granularity of the first control resource set in the present application, and a number of the time-frequency units in the characteristic resource subset in the present application is related to the precoding granularity of the first control resource set.

In one embodiment, the precoding granularity of the first control resource set is either of all Contiguous RBs or REG Bundle.

In one embodiment, the precoding granularity of the first control resource set is a maximum number of REGs that the first node can assume to be employing the same precoding.

In one embodiment, the precoding granularity of the first control resource set is a maximum number of RBs that the first node can assume to be employing the same precoding.

In one embodiment, the precoding granularity of the first control resource set is a time-frequency resource in which any two REGs included can be assumed by the first node to be employing the same precoding.

In one embodiment, the statement in the claims that “the second information block is used to determine precoding granularity of the first control resource set” includes the following meaning: the second information block is used by the first node in the present application to determine the precoding granularity of the first control resource set.

In one embodiment, the statement in the claims that “the second information block is used to determine precoding granularity of the first control resource set” includes the following meaning: one or more fields included in the second information block is/are used to explicitly or implicitly indicate the precoding granularity of the first control resource set.

In one embodiment, the statement in the claims that “the second information block is used to determine precoding granularity of the first control resource set” includes the following meaning: the precoding granularity of the first control resource set is one of all Contiguous RBs or REG Bundle, and the second information block is used to explicitly or implicitly indicate the precoding granularity of the first control resource set from all Contiguous RBs or REG Bundle.

In one embodiment, the statement in the claims that “the second information block is used to determine precoding granularity of the first control resource set” includes the following meaning: the precoding granularity of the first control resource set is one of all Contiguous RBs or REG Bundle, and a field included in the second information block is used to explicitly or implicitly indicate the precoding granularity of the first control resource set from all Contiguous RBs or REG Bundle, while another field or other multiple fields included in the second information block is/are used to explicitly or implicitly indicate the number of REGs included in the precoding granularity of the first control resource set.

In one embodiment, the statement in the claims that “a number of the time-frequency units in the characteristic resource subset is related to the precoding granularity of the first control resource set” includes the following meaning: the precoding granularity of the first control resource set is used to determine the number of the time-frequency units in the characteristic resource subset.

In one embodiment, the statement in the claims that “a number of the time-frequency units in the characteristic resource subset is related to the precoding granularity of the first control resource set” includes the following meaning: the number of the time-frequency units in the characteristic resource subset is equal to the number of REGs included in the precoding granularity of the first control resource set.

In one embodiment, the statement in the claims that “a number of the time-frequency units in the characteristic resource subset is related to the precoding granularity of the first control resource set” includes the following meaning: the number of the time-frequency units in the characteristic resource subset is linear with the number of REGs included in the precoding granularity of the first control resource set.

In one embodiment, the statement in the claims that “a number of the time-frequency units in the characteristic resource subset is related to the precoding granularity of the first control resource set” includes the following meaning: the number of the time-frequency units in the characteristic resource subset is equal to the number of REG Bundles included in the precoding granularity of the first control resource set.

In one embodiment, the statement in the claims that “a number of the time-frequency units in the characteristic resource subset is related to the precoding granularity of the first control resource set” includes the following meaning: the characteristic resource subset is a pre-coded particle employing the precoding granularity of the first control resource set.

In one embodiment, the statement in the claims that “a number of the time-frequency units in the characteristic resource subset is related to the precoding granularity of the first control resource set” includes the following meaning: when the precoding granularity of the first control resource set is all Contiguous RBs, the number of the time-frequency units in the characteristic resource subset is equal to a product of a number of time-domain symbols occupied in time domain by the first control resource set and a number of RBs included in a RB subset included in the first control resource set that occupies consecutive RBs in frequency domain; when the precoding granularity of the first control resource set is REG bundle, the number of the time-frequency units in the characteristic resource subset is equal to a number of REGs included in a REG bundle.

In one embodiment, the statement in the claims that “a number of the time-frequency units in the characteristic resource subset is related to the precoding granularity of the first control resource set” includes the following meaning: when the precoding granularity of the first control resource set is all Contiguous RBs, the number of the time-frequency units in the characteristic resource subset is equal to a number of REGs included in a first control subset, any RE included in the first control subset belongs to the first control resource set, the first control subset and the first control resource set occupy the same time-domain symbols in time domain, and the first control subset occupies consecutive RBs in frequency domain; when the precoding granularity of the first control resource set is REG bundle, the number of the time-frequency units in the characteristic resource subset is equal to a number of REGs included in a REG bundle.

In one embodiment, the first node determines that the same precoding is used in the characteristic resource subset.

In one embodiment, the first node assumes that the same precoding is used in the characteristic resource subset.

In one embodiment, the first node assumes that the same precoding is used for any two time-frequency units included in the characteristic resource subset.

In one embodiment, the first node assumes that the same precoding is used for all time-frequency units included in the characteristic resource subset.

In one embodiment, the first node cannot assume that the same precoding is used for any of the time-frequency units included in the characteristic resource subset and a time-frequency unit outside the characteristic resource subset.

### Embodiment 8

Embodiment 8 illustrates a schematic diagram of the determination of a characteristic relationship according to one embodiment of the present application, as shown in FIG. 8. In FIG. 8, starting with 801, and it is determined in 802 whether there is a capability of monitoring a control channel candidate with RE(s) overlapping with other signals, and it is determined in 803 whether the transmission of the control channel candidate with RE(s) overlapping with other signals is enabled/on or not, in 804 the characteristic relationship is a second relationship, in 805 it is determined whether the index of a first control resource set is equal to 0, in 806 the characteristic relationship is a first relationship.

In Embodiment 8, the third information block in the present application is used to indicate a capability of the first node in the present application, and at least one of the capability of the first node or an index of the first control resource set in the present application is used to determine the characteristic relationship in the present application between the first relationship in the present application or the second relationship in the present application.

In one embodiment, the capability of the first node means: all or a portion of capabilities in a Feature Set of the first node.

In one embodiment, the capability of the first node means: all or a portion of capabilities in a DL Feature Set of the first node.

In one embodiment, the capability of the first node means: all or a portion of capabilities in a Feature Set per component carrier of the first node.

In one embodiment, the capability of the first node means: all or a portion of capabilities specific to the band of the first node.

In one embodiment, the capability of the first node means: all or a portion of capabilities specific to the band list of the first node.

In one embodiment, the capability of the first node means: all or a portion of capabilities of the first node relating to PDCCH monitoring.

In one embodiment, the capability of the first node means: all or a portion of capabilities of the first node relating to monitoring of CRS Punctured PDCCH.

In one embodiment, the capability of the first node means: all or a portion of capabilities of the first node relating to monitoring of PDCCH Punctured by the first-type reference signals.

In one embodiment, the capability of the first node means: the capability of whether the first node supports the presence of at least one overlapping RE between the CORESET and the first-type reference signals.

In one embodiment, an index of the first control resource set is a non-negative integer.

In one embodiment, an index of the first control resource set is a positive integer.

In one embodiment, an index of the first control resource set and an identification (ID) of the first control resource set are equivalent or used interchangeably.

In one embodiment, the second information block is used to explicitly or implicitly indicate an index of the first control resource set.

In one embodiment, the first information block is used to explicitly or implicitly indicate an index of the first control resource set.

In one embodiment, the third information block is used to explicitly or implicitly indicate an index of the first control resource set.

In one embodiment, a signaling other than the second information block is used to explicitly or implicitly indicate an index of the first control resource set.

In one embodiment, the statement in the claims that “at least one of the capability of the first node or an index of the first control resource set is used to determine the characteristic relationship between the first relationship or the second relationship” includes the following meaning: at least one of the capability of the first node or the index of the first control resource set is used by the first node in this application or the second node in this application to determine the characteristic relationship from the first relationship or the second relationship.

In one embodiment, the statement in the claims that “at least one of the capability of the first node or an index of the first control resource set is used to determine the characteristic relationship between the first relationship or the second relationship” includes the following meaning: both of the capability of the first node and the index of the first control resource set are used to determine the characteristic relationship from the first relationship or the second relationship.

In one embodiment, the statement in the claims that “at least one of the capability of the first node or an index of the first control resource set is used to determine the characteristic relationship between the first relationship or the second relationship” includes the following meaning: the capability of the first node is used to determine the characteristic relationship between the first relationship or the second relationship.

In one embodiment, the statement in the claims that “at least one of the capability of the first node or an index of the first control resource set is used to determine the characteristic relationship between the first relationship or the second relationship” includes the following meaning: the index of the first control resource set is used to determine the characteristic relationship between the first relationship or the second relationship.

In one embodiment, the statement in the claims that “at least one of the capability of the first node or an index of the first control resource set is used to determine the characteristic relationship between the first relationship or the second relationship” includes the following meaning: at least one of the capability of the first node or whether the index of the first control resource set is equal to 0 is used to determine the characteristic relationship between the first relationship or the second relationship.

In one embodiment, the statement in the claims that “at least one of the capability of the first node or an index of the first control resource set is used to determine the characteristic relationship between the first relationship or the second relationship” includes the following meaning: at least one of the capability of the first node or whether the index of the first control resource set is equal to an index of a control resource set associated with a search space set with index equal to 0 is used to determine the characteristic relationship between the first relationship or the second relationship.

In one embodiment, the statement in the claims that “at least one of the capability of the first node or an index of the first control resource set is used to determine the characteristic relationship between the first relationship or the second relationship” includes the following meaning: at least one of the capability of the first node or whether the index of the first control resource set is equal to an index of a control resource set associated with a common search space set is used to determine the characteristic relationship between the first relationship or the second relationship.

In one embodiment, the statement in the claims that “at least one of the capability of the first node or an index of the first control resource set is used to determine the characteristic relationship between the first relationship or the second relationship” includes the following meaning: the characteristic relationship is the second relationship when the capability of the first node does not support the PDCCH being punctured by the CRS; the characteristic relationship is the first relationship when the capability of the first node supports the PDCCH being punctured by the CRS.

In one embodiment, the statement in the claims that “at least one of the capability of the first node or an index of the first control resource set is used to determine the characteristic relationship between the first relationship or the second relationship” includes the following meaning: the characteristic relationship is the second relationship when the capability of the first node supports only PDCCHs of Release 17 and earlier versions; the characteristic relationship is the first relationship when the capability of the first node supports PDCCHs of Release 18.

In one embodiment, the statement in the claims that “at least one of the capability of the first node or an index of the first control resource set is used to determine the characteristic relationship between the first relationship or the second relationship” includes the following meaning: the characteristic relationship is the second relationship when the capability of the first node supports only PDCCHs of Release 17 and earlier versions; the characteristic relationship is the first relationship when the capability of the first node supports PDCCHs of Release 18 and a higher layer parameter or signaling enables or configures a PDCCH of R18; the characteristic relationship is the second relationship when the capability of the first node supports PDCCHs of Release 18 but a higher layer parameter or signaling disables the PDCCH of R18.

In one embodiment, the statement in the claims that “at least one of the capability of the first node or an index of the first control resource set is used to determine the characteristic relationship between the first relationship or the second relationship” includes the following meaning: the characteristic relationship is the second relationship when a first capability is not supported by the first node; the characteristic relationship is the first relationship when the first capability is supported by the first node. In one subsidiary embodiment of the above embodiment, the first capability is the capability to support CRS puncturing PDCCH. In one subsidiary embodiment of the above embodiment, the first capability is the capability to support the presence of at least one overlapping RE between the CORESET and the first-type reference signals. In one subsidiary embodiment of the above embodiment, the first capability is the capability to support R18 PDCCHs.

In one embodiment, the statement in the claims that “at least one of the capability of the first node or an index of the first control resource set is used to determine the characteristic relationship between the first relationship or the second relationship” includes the following meaning: the characteristic relationship is the second relationship when the first node does not support a first capability; the characteristic relationship is the first relationship when the first node supports the first capability and a higher layer parameter or signaling indicates enabling; the characteristic relationship is the second relationship when the first node supports the first capability but a higher layer parameter or signaling indicates disabling. In one subsidiary embodiment of the above embodiment, the first capability is the capability to support CRS puncturing PDCCH. In one subsidiary embodiment of the above embodiment, the first capability is the capability to support the presence of at least one overlapping RE between the CORESET and the first-type reference signals. In one subsidiary embodiment of the above embodiment, the first capability is the capability to support R18 PDCCHs.

In one embodiment, the statement in the claims that “at least one of the capability of the first node or an index of the first control resource set is used to determine the characteristic relationship between the first relationship or the second relationship” includes the following meaning: the characteristic relationship is the second relationship when the first node does not provide a first parameter or when the first parameter is provided but the first parameter indicates that the first capability is not supported; the characteristic relationship is the first relationship when the first node provides the first parameter and the first parameter indicates that the first capability is supported. In one subsidiary embodiment of the above embodiment, the first capability is the capability to support CRS puncturing PDCCH. In one subsidiary embodiment of the above embodiment, the first capability is the capability to support the presence of at least one overlapping RE between the CORESET and the first-type reference signals. In one subsidiary embodiment of the above embodiment, the first capability is the capability to support R18 PDCCHs.

In one embodiment, the statement in the claims that “at least one of the capability of the first node or an index of the first control resource set is used to determine the characteristic relationship between the first relationship or the second relationship” includes the following meaning: the characteristic relationship is the second relationship when the first node does not provide a first parameter or when the first parameter is provided but the first parameter indicates that the first capability is not supported; the characteristic relationship is the first relationship when the first parameter is provided by the first node and the first parameter indicates that the first capability is supported and a higher layer parameter or signaling indicates enabling; the characteristic relationship is the second relationship when the first node provides the first parameter and the first parameter indicates that the first capability is supported but a higher layer parameter or signaling indicates disabling; the first parameter is a parameter included in the capability report of the first node. In one subsidiary embodiment of the above embodiment, the first capability is the capability to support CRS puncturing PDCCH. In one subsidiary embodiment of the above embodiment, the first capability is the capability to support the presence of at least one overlapping RE between the CORESET and the first-type reference signals. In one subsidiary embodiment of the above embodiment, the first capability is the capability to support R18 PDCCHs.

In one embodiment, the statement in the claims that “at least one of the capability of the first node or an index of the first control resource set is used to determine the characteristic relationship between the first relationship or the second relationship” includes the following meaning: the characteristic relationship is the second relationship when the index of the first control resource set is equal to 0; the characteristic relationship is the first relationship when the index of the first control resource set is greater than 0.

In one embodiment, the statement in the claims that “at least one of the capability of the first node or an index of the first control resource set is used to determine the characteristic relationship between the first relationship or the second relationship” includes the following meaning: when the index of the first control resource set is equal to an index of a control resource set associated with a search space set with index equal to 0, the characteristic relationship is the second relationship; otherwise, the characteristic relationship is the first relationship.

In one embodiment, the statement in the claims that “at least one of the capability of the first node or an index of the first control resource set is used to determine the characteristic relationship between the first relationship or the second relationship” includes the following meaning: when the index of the first control resource set is equal to an index of a control resource set associated with a common search space set of a pre-defined type, the characteristic relationship is the second relationship; otherwise, the characteristic relationship is the first relationship.

In one embodiment, the statement in the claims that “at least one of the capability of the first node or an index of the first control resource set is used to determine the characteristic relationship between the first relationship or the second relationship” includes the following meaning: the characteristic relationship is the first relationship only if the first node provides the first parameter and the first parameter indicates support for the first capability and the index of the first control resource set is not equal to 0; in other cases the characteristic relationship is the second relationship; the first parameter is a parameter included in the capability report of the first node. In one subsidiary embodiment of the above embodiment, the first capability is the capability to support CRS puncturing PDCCH. In one subsidiary embodiment of the above embodiment, the first capability is the capability to support the presence of at least one overlapping RE between the CORESET and the first-type reference signals. In one subsidiary embodiment of the above embodiment, the first capability is the capability to support R18 PDCCHs.

In one embodiment, the statement in the claims that “at least one of the capability of the first node or an index of the first control resource set is used to determine the characteristic relationship between the first relationship or the second relationship” includes the following meaning: the characteristic relationship is the first relationship only if the first node provides the first parameter and the first parameter indicates support for the first capability and a higher layer parameter or signaling indicates enabling and the index of the first control resource set is not equal to 0; in other cases the characteristic relationship is the second relationship; the first parameter is a parameter included in the capability report of the first node. In one subsidiary embodiment of the above embodiment, the first capability is the capability to support CRS puncturing PDCCH. In one subsidiary embodiment of the above embodiment, the first capability is the capability to support the presence of at least one overlapping RE between the CORESET and the first-type reference signals. In one subsidiary embodiment of the above embodiment, the first capability is the capability to support R18 PDCCHs.

In one embodiment, the statement in the claims that “at least one of the capability of the first node or an index of the first control resource set is used to determine the characteristic relationship between the first relationship or the second relationship” includes the following meaning: the characteristic relationship is the first relationship only if the first node provides the first parameter and the first parameter indicates support for the first capability and the index of the first control resource set is not equal to an index of a control resource set associated with a common search space set of a pre-defined type; in other cases the characteristic relationship is the second relationship; the first parameter is a parameter included in the capability report of the first node. In one subsidiary embodiment of the above embodiment, the first capability is the capability to support CRS puncturing PDCCH. In one subsidiary embodiment of the above embodiment, the first capability is the capability to support the presence of at least one overlapping RE between the CORESET and the first-type reference signals. In one subsidiary embodiment of the above embodiment, the first capability is the capability to support R18 PDCCHs.

In one embodiment, the statement in the claims that “at least one of the capability of the first node or an index of the first control resource set is used to determine the characteristic relationship between the first relationship or the second relationship” includes the following meaning: the characteristic relationship is the second relationship when the index of the first control resource set is equal to 0; the characteristic relationship is the second relationship when the first node does not provide a first parameter or when the first parameter is provided but the first parameter indicates that the first capability is not supported; the characteristic relationship is the first relationship when the first node provides the first parameter and the first parameter indicates that the first capability is supported and the index of the first control resource set is not equal to 0; the first parameter is a parameter included in the capability report of the first node. In one subsidiary embodiment of the above embodiment, the first capability is the capability to support CRS puncturing PDCCH. In one subsidiary embodiment of the above embodiment, the first capability is the capability to support the presence of at least one overlapping RE between the CORESET and the first-type reference signals. In one subsidiary embodiment of the above embodiment, the first capability is the capability to support R18 PDCCHs.

In one embodiment, the statement in the claims that “at least one of the capability of the first node or an index of the first control resource set is used to determine the characteristic relationship between the first relationship or the second relationship” includes the following meaning: the characteristic relationship is the second relationship when the index of the first control resource set is equal to 0; the characteristic relationship is the second relationship when the first node does not provide a first parameter or when the first parameter is provided but the first parameter indicates that the first capability is not supported; the characteristic relationship is the second relationship when the first parameter is provided by the first node and the first parameter indicates that the first capability is supported but a higher layer parameter or signaling indicates disabling; the characteristic relationship is the first relationship when the first node provides the first parameter and the first parameter indicates that the first capability is supported and a higher layer parameter or signaling indicates enabling and the index of the first control resource set is not equal to 0; the first parameter is a parameter included in the capability report of the first node. In one subsidiary embodiment of the above embodiment, the first capability is the capability to support CRS puncturing PDCCH. In one subsidiary embodiment of the above embodiment, the first capability is the capability to support the presence of at least one overlapping RE between the CORESET and the first-type reference signals. In one subsidiary embodiment of the above embodiment, the first capability is the capability to support R18 PDCCHs.

### Embodiment 9

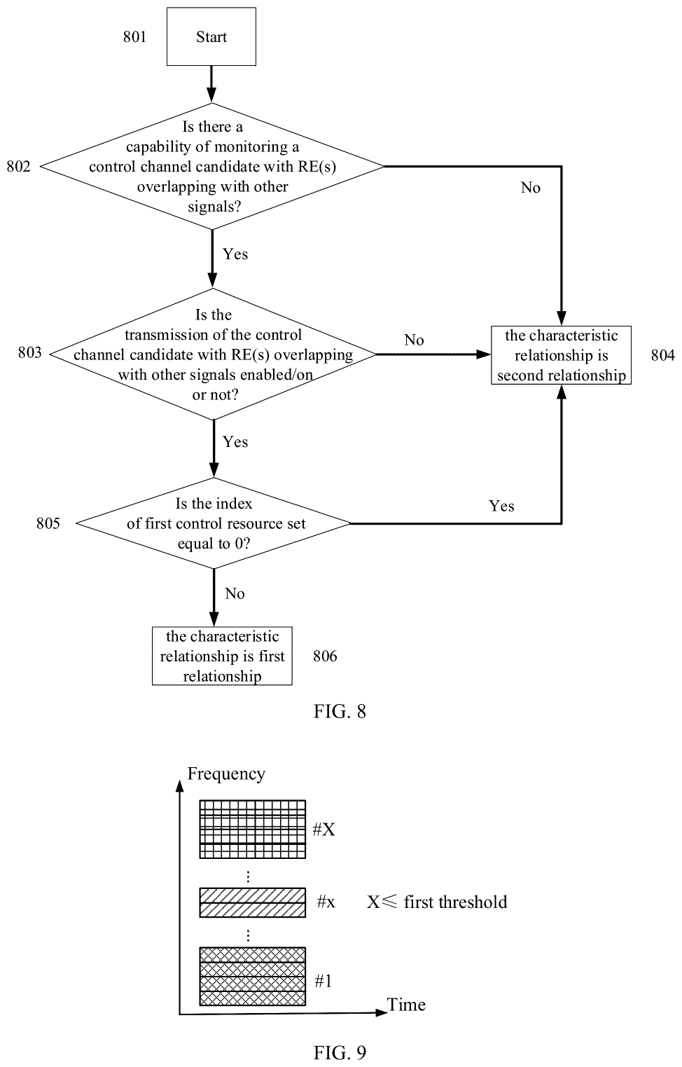

Embodiment 9 illustrates a schematic diagram of a first threshold according to one embodiment of the present application, as shown in FIG. 9. In FIG. 9, the horizontal axis represents time, the vertical axis represents frequency, and each filled rectangular box represents an RB occupied by a first control resource set in the frequency domain, and rectangles with the same filling constitute a non-consecutive RB subset, and X denotes the number of non-consecutive RB subsets in the first control resource set.

In Embodiment 9, the precoding granularity of the first control resource set in this application refers to all contiguous RBs, and a number of non-contiguous RB subset(s) included in the first control resource set in frequency domain is no greater than a first threshold, the first threshold being a positive integer greater than 1; the first threshold is fixed, or the first threshold is related to whether the characteristic relationship in this application is the first relationship in this application or the second relationship in this application.

In one embodiment, the first node of the present application assumes that the same precoding is used for any two REGs belonging to a same RB subset including consecutive RBs in the frequency domain.

In one embodiment, the first node of the present application assumes that the same precoding is used for all REGs belonging to any RB subset including consecutive RBs in the frequency domain.

In one embodiment, when the first control resource set includes only consecutive RBs in frequency domain, the number of discontinuous RB subset(s) included in the first control resource set in frequency domain is equal to 1.

In one embodiment, any discontinuous RB subset included in frequency domain by the first control resource set includes contiguous RBs in the frequency domain.

In one embodiment, any discontinuous RB subset included in frequency domain by the first control resource set includes at least one RB.

In one embodiment, when the number of discontinuous RB subsets included in frequency domain by the first control resource set is greater than 1, any two discontinuous RB subsets included in frequency domain by the first control resource set together include frequency-domain discrete RBs.

In one embodiment, any discontinuous RB subset included in frequency domain by the first control resource set includes RBs that are contiguous in frequency domain; when the number of discontinuous RB subsets included in frequency domain by the first control resource set is greater than 1, there exists an RB other than the RBs included in the frequency domain by the first control resource set that lies between two discontinuous RB subsets included in the first control resource set in frequency domain.

In one embodiment, when the number of discontinuous RB subsets included in frequency domain by the first control resource set is greater than 1, there exists an RB other than the RBs included in the frequency domain by the first control resource set that lies between two discontinuous RB subsets included in the first control resource set in frequency domain.

In one embodiment, a bitmap indicated by the second information block is used to indicate RBs included in the first control resource set in frequency domain.

In one embodiment, the first threshold is fixed to be equal to 4.

In one embodiment, the first threshold is greater than 4.

In one embodiment, a capability report of the first node is used to indicate whether the first threshold can be greater than 4.

In one embodiment, a capability report of the first node is used to indicate whether the first node supports the first threshold being greater than 4.

In one embodiment, the statement in the claims that “the first threshold is related to whether the characteristic relationship is the first relationship or the second relationship” includes the following meaning: whether the characteristic relationship is the first relationship or the second relationship is used to determine the first threshold.

In one embodiment, the statement in the claims that “the first threshold is related to whether the characteristic relationship is the first relationship or the second relationship” includes the following meaning: whether the characteristic relationship is the first relationship or the second relationship is used to determine whether the first threshold is greater than 4.

In one embodiment, the statement in the claims that “the first threshold is related to whether the characteristic relationship is the first relationship or the second relationship” includes the following meaning: whether the first threshold is greater than 4 is used to determine the characteristic relationship between the first relationship or the second relationship.

In one embodiment, the statement in the claims that “the first threshold is related to whether the characteristic relationship is the first relationship or the second relationship” means that when the characteristic relationship is the first relationship, the first threshold is greater than 4; when the characteristic relationship is the second relationship, the first threshold is equal to 4.

In one embodiment, the statement in the claims that “the first threshold is related to whether the characteristic relationship is the first relationship or the second relationship” means that when the characteristic relationship is the first relationship, the first threshold is equal to 4; when the characteristic relationship is the second relationship, the first threshold is greater than 4.

In one embodiment, the statement in the claims that “the first threshold is related to whether the characteristic relationship is the first relationship or the second relationship” means that when the first threshold is greater than 4, the characteristic relationship is the first relationship; when the first threshold is equal to 4, the characteristic relationship is the second relationship.

In one embodiment, the statement in the claims that “the first threshold is related to whether the characteristic relationship is the first relationship or the second relationship” means that when the first threshold is equal to 4, the characteristic relationship is the first relationship; when the first threshold is greater than 4, the characteristic relationship is the second relationship.

In one embodiment, the statement in the claims that “the first threshold is related to whether the characteristic relationship is the first relationship or the second relationship” means that both the first threshold and whether the characteristic relationship is the first relationship or the second relationship are related to a same parameter.

In one embodiment, the statement in the claims that “the first threshold is related to whether the characteristic relationship is the first relationship or the second relationship” means that a same capability parameter is used to determine both the first threshold and whether the characteristic relationship is the first relationship or the second relationship.

In one embodiment, the statement in the claims that “the first threshold is related to whether the characteristic relationship is the first relationship or the second relationship” means that a same capability parameter is used to determine whether the first threshold is greater than 4 and whether the characteristic relationship is the first relationship or the second relationship.

### Embodiment 10

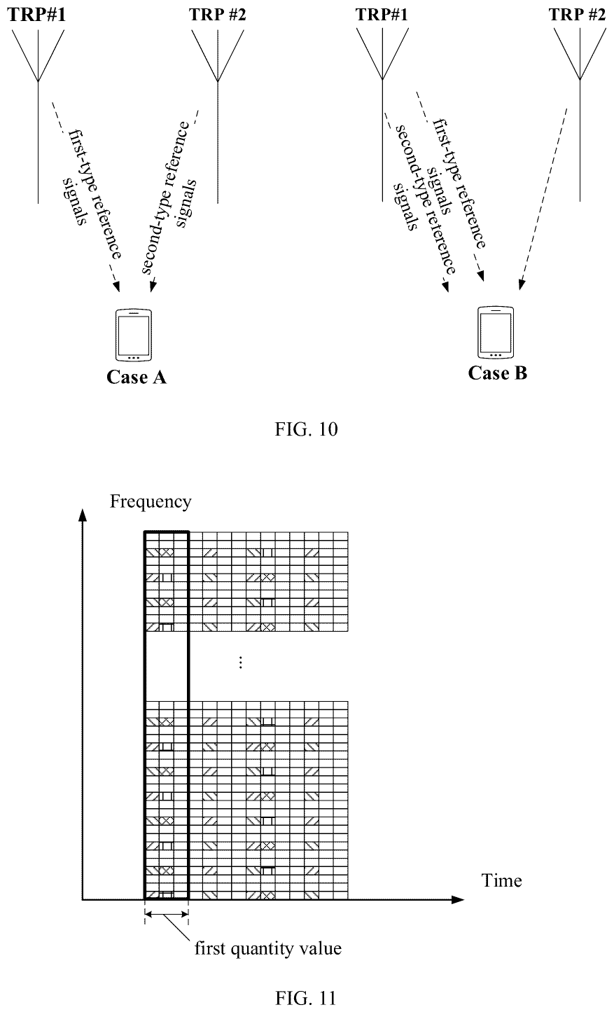

Embodiment 10 illustrates a schematic diagram of the relationship between first-type reference signals and second-type reference signals according to one embodiment of the present application, as shown in FIG. 10. In Case A and Case B of FIG. 10, TRP #1 and TRP #2 represent two Transmit Receive Points (TRPs) or two different antenna port groups, respectively; in Case A, the first-type reference signals and the second-type reference signals are not quasi-co-located; in Case B, the first-type reference signals and the second-type reference signals are quasi-co-located.

In Embodiment 10, the first information block in the present application is used to determine at least one of whether there is quasi-colocation between the first-type reference signals and the second-type reference signals of this application, or the type of quasi-colocation relationship between the first-type reference signals and the second-type reference signals.

In one embodiment, the statement in the claims that “the first information block is used to determine at least one of whether there is quasi-colocation between the first-type reference signals and the second-type reference signals, or the type of quasi-colocation relationship between the first-type reference signals and the second-type reference signals” includes the following meaning: the first information block is used by the first node in this application to determine at least one of whether there is Quasi-CoLocation (QCL) between the first-type reference signals and the second-type reference signals, or the type of QCL relationship between the first-type reference signals and the second-type reference signals.

In one embodiment, the statement in the claims that “the first information block is used to determine at least one of whether there is quasi-colocation between the first-type reference signals and the second-type reference signals, or the type of quasi-colocation relationship between the first-type reference signals and the second-type reference signals” includes the following meaning: the first information block is used to indicate, explicitly or implicitly, at least one of whether there is Quasi-CoLocation (QCL) between the first-type reference signals and the second-type reference signals, or the type of QCL relationship between the first-type reference signals and the second-type reference signals.

In one embodiment, the statement in the claims that “the first information block is used to determine at least one of whether there is quasi-colocation between the first-type reference signals and the second-type reference signals, or the type of quasi-colocation relationship between the first-type reference signals and the second-type reference signals” includes the following meaning: the first information block is used to indicate, explicitly or implicitly, whether there is Quasi-CoLocation (QCL) between the first-type reference signals and the second-type reference signals, as well as the type of QCL relationship between the first-type reference signals and the second-type reference signals.

In one embodiment, the statement in the claims that “the first information block is used to determine at least one of whether there is quasi-colocation between the first-type reference signals and the second-type reference signals, or the type of quasi-colocation relationship between the first-type reference signals and the second-type reference signals” includes the following meaning: the first information block is used to indicate, explicitly or implicitly, whether there is Quasi-CoLocation (QCL) between the first-type reference signals and the second-type reference signals.

In one embodiment, the statement in the claims that “the first information block is used to determine at least one of whether there is quasi-colocation between the first-type reference signals and the second-type reference signals, or the type of quasi-colocation relationship between the first-type reference signals and the second-type reference signals” includes the following meaning: the first information block is used to indicate, explicitly or implicitly, the type of QCL relationship between the first-type reference signals and the second-type reference signals.

In one embodiment, the statement in the claims that “the first information block is used to determine at least one of whether there is quasi-colocation between the first-type reference signals and the second-type reference signals, or the type of quasi-colocation relationship between the first-type reference signals and the second-type reference signals” includes the following meaning: the first information block is used to indicate, explicitly or implicitly, whether there is Quasi-CoLocation (QCL) between the first-type reference signals and the second-type reference signals, as well as to indicate the type of QCL relationship between the first-type reference signals and the second-type reference signals when there is QCL between the first-type reference signals and the second-type reference signals.

In one embodiment, the statement in the claims that “the first information block is used to determine at least one of whether there is quasi-colocation between the first-type reference signals and the second-type reference signals, or the type of quasi-colocation relationship between the first-type reference signals and the second-type reference signals” includes the following meaning: the first information block is used to indicate, explicitly or implicitly, at least one of whether the first node can assume whether there is Quasi-CoLocation (QCL) between the first-type reference signals and the second-type reference signals, or the type of QCL relationship between the first-type reference signals and the second-type reference signals assumed by the first node.

In one embodiment, “the first information block is used to determine whether there is quasi-colocation between the first-type reference signals and the second-type reference signals” includes the following meaning: the first information block is used to determine whether quasi-colocation is possible between an antenna port of the first-type reference signals occupying at least one RE included in the first RE set and an antenna port of the second-type reference signals occupying at least one RE included in the first control resource set.

In one embodiment, “the first information block is used to determine whether there is quasi-colocation between the first-type reference signals and the second-type reference signals” includes the following meaning: the first information block is used to determine whether there is quasi-colocation between at least one antenna port of the first-type reference signals and at least one antenna port of the second-type reference signals.

In one embodiment, “the first information block is used to determine whether there is quasi-colocation between the first-type reference signals and the second-type reference signals” includes the following meaning: the first information block is used to indicate, explicitly or implicitly, whether the first node can assume that there is quasi-colocation between at least one antenna port of the first-type reference signals and at least one antenna port of the second-type reference signals.

In one embodiment, “the first information block is used to determine whether there is quasi-colocation between the first-type reference signals and the second-type reference signals” includes the following meaning: the first information block is used to indicate, explicitly or implicitly, quasi-colocation between the first-type reference signals and third-type reference signals, and quasi-colocation between the second-type reference signals and the third-type reference signals, the third-type reference signals being reference signals different from the first-type reference signals and the second-type reference signals. In one subsidiary embodiment of the above embodiment, the third-type reference signal is CSI-RS. In one subsidiary embodiment of the above embodiment, the third-type reference signal is non-zero power (NZP) CSI-RS. In one subsidiary embodiment of the above embodiment, the third-type reference signal is SSB. In one subsidiary embodiment of the above embodiment, the first information block is also used to explicitly or implicitly indicate an ID of a bandwidth part (BWP) to which the third-type reference signals quasi co-located with the first-type reference signals belong. In one subsidiary embodiment of the above embodiment, the first information block is also used to explicitly or implicitly indicate an ID of a serving cell to which the third-type reference signals quasi co-located with the first-type reference signals belong. In one subsidiary embodiment of the above embodiment, the first information block is used to explicitly or implicitly indicate an ID or index of the third-type reference signals quasi co-located with the first-type reference signals. In one subsidiary embodiment of the above embodiment, the first information block is used to explicitly or implicitly indicate an antenna port number of the third-type reference signals quasi co-located with the first-type reference signals. In one subsidiary embodiment of the above embodiment, the first information block is used to explicitly or implicitly indicate whether there is a particular type of quasi-colocation relationship between the first-type reference signals and the third-type reference signals; in one subsidiary embodiment of the above embodiment, the first information block is used to explicitly or implicitly indicate whether there is a typeD quasi-colocation relationship between the first-type reference signals and the third-type reference signals.

In one embodiment, the type of quasi-colocation relationship between the first-type reference signals and the second-type reference signals is one of type A, type B, type C or type D.

In one embodiment, the type of quasi-colocation relationship between the first-type reference signals and the second-type reference signals is one of type A, type B, or type C.

In one embodiment, the type of quasi-colocation relationship between the first-type reference signals and the second-type reference signals is one of type A or type D.

In one embodiment, the type of quasi-colocation relationship between the first-type reference signals and the second-type reference signals is one of type1 or type2.

In one embodiment, the type of quasi-colocation relationship between the first-type reference signals and the second-type reference signals is one of a QCL type that includes small-scale fading or a QCL type that includes only large-scale fading.

In one embodiment, the type of quasi-colocation relationship between the first-type reference signals and the second-type reference signals is one of a QCL type that includes spatial Rx parameters or a QCL type that does not include spatial Rx parameters.

In one embodiment, the type of quasi-colocation relationship between the first-type reference signals and the second-type reference signals is one of a QCL type that includes delay spread or a QCL type that does not include delay spread.

In one embodiment, the type of quasi-colocation relationship between the first-type reference signals and the second-type reference signals includes: the type of quasi-colocation relationship between at least one antenna port of the first-type reference signals and at least one antenna port of the second-type reference signals.

In one embodiment, the type of quasi-colocation relationship between the first-type reference signals and the second-type reference signals includes: the type of quasi-colocation relationship between an antenna port of the first-type reference signals occupying at least one RE included in the first RE set and an antenna port of the second-type reference signals occupying at least one RE included in the first control resource set.

In one embodiment, that the first information block is used to determine the type of quasi-colocation relationship between the first-type reference signals and the second-type reference signals includes the following meaning: the first information block is used to indicate, explicitly or implicitly, the type of the quasi-colocation relationship between the first-type reference signals and the second-type reference signals assumed by the first node.

In one embodiment, that the first information block is used to determine the type of quasi-colocation relationship between the first-type reference signals and the second-type reference signals includes the following meaning: two fields included in the first information block are used to indicate the ID or index of the first-type reference signals and the ID or index of the second-type reference signals and the type of quasi-colocation relationship, respectively.

In one embodiment, “the first information block is used to determine whether there is quasi-colocation between the first-type reference signals and the second-type reference signals” includes the following meaning: the first information block is used to indicate, explicitly or implicitly, quasi-colocation between the first-type reference signals and third-type reference signals, and the second information block is used to explicitly or implicitly indicate quasi-colocation of the second-type reference signals and the third-type reference signals and the type of the quasi-colocation relationship between the second-type reference signals and the third-type reference signals, the third-type reference signals being reference signals different from the first-type reference signals and the second-type reference signals. In one subsidiary embodiment of the above embodiment, the third-type reference signal is CSI-RS. In one subsidiary embodiment of the above embodiment, the third-type reference signal is non-zero power (NZP) CSI-RS. In one subsidiary embodiment of the above embodiment, the third-type reference signal is SSB. In one subsidiary embodiment of the above embodiment, the first information block is also used to explicitly or implicitly indicate an ID of a bandwidth part (BWP) to which the third-type reference signals quasi co-located with the first-type reference signals belong. In one subsidiary embodiment of the above embodiment, the first information block is also used to explicitly or implicitly indicate an ID of a serving cell to which the third-type reference signals quasi co-located with the first-type reference signals belong. In one subsidiary embodiment of the above embodiment, the first information block is used to explicitly or implicitly indicate an ID or index of the third-type reference signals quasi co-located with the first-type reference signals. In one subsidiary embodiment of the above embodiment, the first information block is used to explicitly or implicitly indicate an antenna port number of the third-type reference signals quasi co-located with the first-type reference signals.

### Embodiment 11

Embodiment 11 illustrates a schematic diagram of a first quantity value according to one embodiment of the present application, as shown in FIG. 11. In FIG. 11, the horizontal axis represents time, and the vertical axis represents frequency; each small rectangular box represents an RE, each filled rectangular box represents an RE in the first RE set, and the small rectangular boxes circled by the thick-line framed rectangles represent the REs included in the first control resource set.

In Embodiment 11, a first quantity value is equal to a number of time-domain symbols occupied in time domain by the first control resource set in this application, and a number of time-domain symbols occupied in time domain by the characteristic resource subset in this application is equal to the first quantity value; the fourth information block in this application is used to determine a target quantity set, the target quantity set including multiple quantity values, and the second information block in this application is used to determine the first quantity value from the target quantity set; the first quantity value is used to determine the characteristic relationship in this application between the first relationship or the second relationship in this application.

In one embodiment, when the first quantity value is greater than 1, the first control resource set occupies consecutive time-domain symbols in time domain.

In one embodiment, any time-domain symbol occupied by the first control resource set in time domain is an OFDM symbol.

In one embodiment, any time-domain symbol occupied by the first control resource set in time domain comprises a cyclic prefix (CP) portion and a data portion.

In one embodiment, any time-domain symbol occupied by the characteristic resource subset in time domain is an OFDM symbol.

In one embodiment, any time-domain symbol occupied by the characteristic resource subset in time domain comprises a cyclic prefix (CP, cyclic prefix) portion and a data portion.

In one embodiment, the first quantity value is equal to one of 1, 2 or 3.

In one embodiment, the first quantity value is equal to one of 1 or 2.

In one embodiment, the first quantity value can be greater than 3.

In one embodiment, the quantity values included in the target quantity set are equal to 1, 2, and 3, respectively.

In one embodiment, the quantity values included in the target quantity set are equal to 1 and 2, respectively.

In one embodiment, any quantity value included in the target quantity set is a positive integer.

In one embodiment, the number of quantity values included in the target quantity set is equal to one of 2 or 3.

In one embodiment, any quantity value included in the target quantity set is equal to the number of time-domain symbols in a duration of a possible CORESET in the time domain.

In one embodiment, the statement in the claims that “the second information block is used to determine the first quantity value out of the target quantity set” includes the following meaning: the second information block is used by the first node in the present application to determine the first quantity value from the target quantity set.

In one embodiment, the statement in the claims that “the second information block is used to determine the first quantity value out of the target quantity set” includes the following meaning: a field included in the second information block is used to explicitly or implicitly indicate the first quantity value in the target quantity set.

In one embodiment, the statement in the claims that “the second information block is used to determine the first quantity value out of the target quantity set” includes the following meaning: a field included in the second information block is used to explicitly or implicitly indicate a duration of the first control resource set in time domain, the duration of the first control resource set in the time domain being expressed in terms of the first quantity value included in the target quantity set.

In one embodiment, the statement in the claims that “the first quantity value is used to determine the characteristic relationship between the first relationship or the second relationship” includes the following meaning: the first quantity value is used by the first node or the second node in this application to determine the characteristic relationship from the first relationship or the second relationship.

In one embodiment, the statement in the claims that “the first quantity value is used to determine the characteristic relationship between the first relationship or the second relationship” includes the following meaning: the first quantity value is used to determine the characteristic relationship between the first relationship or the second relationship based on conditional relationships.

In one embodiment, the statement in the claims that “the first quantity value is used to determine the characteristic relationship between the first relationship or the second relationship” includes the following meaning: a magnitude relationship between the first quantity value and a predefined threshold value is used to determine the characteristic relationship between the first relationship or the second relationship.

In one embodiment, the statement in the claims that “the first quantity value is used to determine the characteristic relationship between the first relationship or the second relationship” includes the following meaning: when the first quantity value is greater than 2, the characteristic relationship is the second relationship; otherwise, the characteristic relationship is the first relationship.

In one embodiment, the statement in the claims that “the first quantity value is used to determine the characteristic relationship between the first relationship or the second relationship” includes the following meaning: when the first quantity value is greater than 2, the characteristic relationship is the second relationship; otherwise, the characteristic relationship is one of the first relationship or the second relationship.

In one embodiment, the statement in the claims that “the first quantity value is used to determine the characteristic relationship between the first relationship or the second relationship” includes the following meaning: when the first quantity value is greater than 2, the characteristic relationship is the second relationship; otherwise, at least one of the capability of the first node or an index of the first control resource set is used to determine the characteristic relationship between the first relationship or the second relationship.

In one embodiment, the statement in the claims that “the first quantity value is used to determine the characteristic relationship between the first relationship or the second relationship” includes the following meaning: when the first quantity value is greater than 1, the characteristic relationship is the second relationship; otherwise, the characteristic relationship is one of the first relationship or the second relationship.

In one embodiment, the statement in the claims that “the first quantity value is used to determine the characteristic relationship between the first relationship or the second relationship” includes the following meaning: when the first quantity value is greater than 1, the characteristic relationship is the second relationship; otherwise, at least one of the capability of the first node or an index of the first control resource set is used to determine the characteristic relationship between the first relationship or the second relationship.

In one embodiment, the statement in the claims that “the first quantity value is used to determine the characteristic relationship between the first relationship or the second relationship” includes the following meaning: when the first quantity value is greater than the number of time-domain symbols where the first control resource set overlaps with the first RE set in time domain, the characteristic relationship is the second relationship; otherwise, the characteristic relationship is one of the first relationship or the second relationship.

In one embodiment, the statement in the claims that “the first quantity value is used to determine the characteristic relationship between the first relationship or the second relationship” includes the following meaning: when the first quantity value is greater than the number of time-domain symbols where the first control resource set overlaps with the first RE set in time domain, the characteristic relationship is the second relationship; otherwise, at least one of the capability of the first node or an index of the first control resource set is used to determine the characteristic relationship between the first relationship or the second relationship.

In one embodiment, the statement in the claims that “the first quantity value is used to determine the characteristic relationship between the first relationship or the second relationship” includes the following meaning: when the first quantity value is greater than a maximum number of consecutive symbols included in time domain in the first RE set, the characteristic relationship is the second relationship; otherwise, the characteristic relationship is one of the first relationship or the second relationship.

In one embodiment, the statement in the claims that “the first quantity value is used to determine the characteristic relationship between the first relationship or the second relationship” includes the following meaning: when the first quantity value is greater than a maximum number of consecutive symbols included in time domain in the first RE set, the characteristic relationship is the second relationship; otherwise, at least one of the capability of the first node or an index of the first control resource set is used to determine the characteristic relationship between the first relationship or the second relationship.

### Embodiment 12

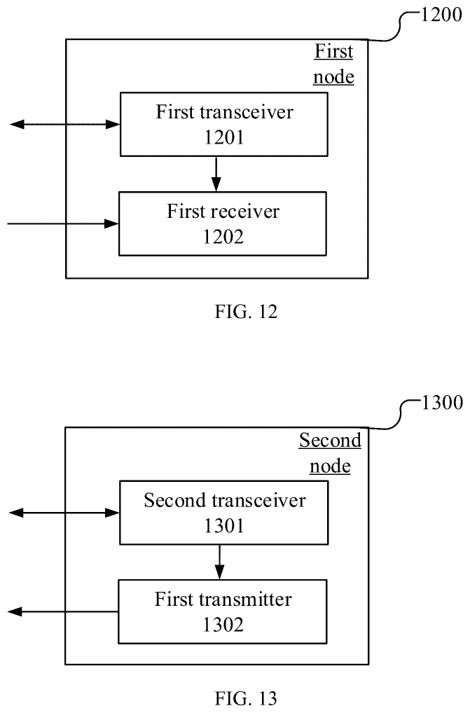

Embodiment 12 illustrates a structure block diagram of a processing device in a first node in an example, as shown in FIG. 12. In FIG. 12, a processing device 1200 in the first node comprises a first transceiver 1201 and a first receiver 1202. The first transceiver 1201 comprises the transmitter/receiver 456 (comprising the antenna 460), the receiving processor 452, the transmitting processor 455 and the controller/processor 490 in FIG. 4 of the present application; the first receiver 1202 comprises the transmitter/receiver 456 (comprising the antenna 460), the receiving processor 452 and the controller/processor 490 in FIG. 4 of the present application.

In Embodiment 12, the first transceiver 1201 receives a first information block and receives a second information block, the first information block being used to determine a first RE set, the first RE set comprising at least one RE, and any RE in the first RE set being used for first-type reference signals; and the first receiver 1202 monitors control channel candidates in a first control resource set, the first control resource set comprising multiple REs, and the first control resource set comprising at least one RE being used for second-type reference signals, the second-type reference signals and the first-type reference signals being two different types of reference signals, the second-type reference signals being used for demodulation of control channels; herein, the second information block is used to determine a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set.

In one embodiment, the first information block comprises a first sub-information-block and a second sub-information-block, the first sub-information-block being used to determine a number of antenna ports of the first-type reference signals, the second sub-information-block being used to determine a frequency-domain location of REs comprised by the first RE set, and at least one of the number of the antenna ports of the first-type reference signals or the frequency-domain location of the REs comprised by the first RE set being used to determine the characteristic relationship between the first relationship or the second relationship.

In one embodiment, the second information block is used to determine precoding granularity of the first control resource set, and a number of the time-frequency units in the characteristic resource subset is related to the precoding granularity of the first control resource set.

In one embodiment, the first transceiver 1201 transmits a third information block; herein, the third information block is used to indicate a capability of the first node, and at least one of the capability of the first node or an index of the first control resource set is used to determine the characteristic relationship between the first relationship or the second relationship.

In one embodiment, the precoding granularity of the first control resource set refers to all contiguous RBs, and a number of non-contiguous RB subset(s) included in the first control resource set in frequency domain is no greater than a first threshold, the first threshold being a positive integer greater than 1; the first threshold is fixed, or the first threshold is related to whether the characteristic relationship is the first relationship or the second relationship.

In one embodiment, the first information block is used to determine at least one of whether there is quasi-colocation between the first-type reference signals and the second-type reference signals, or the type of quasi-colocation relationship between the first-type reference signals and the second-type reference signals.

In one embodiment, the first transceiver 1201 receives a fourth information block; herein, a first quantity value is equal to a number of time-domain symbols occupied in time domain by the first control resource set, and a number of time-domain symbols occupied in time domain by the characteristic resource subset is equal to the first quantity value; the fourth information block is used to determine a target quantity set, the target quantity set including multiple quantity values, and the second information block is used to determine the first quantity value out of the target quantity set; the first quantity value is used to determine the characteristic relationship between the first relationship or the second relationship.

### Embodiment 13

Embodiment 13 illustrates a structure block diagram of a processing device in a second node in an example, as shown in FIG. 13. In FIG. 13, a processing device 1300 in the second node comprises a second transceiver 1301 and a first transmitter 1302. The second transceiver 1301 comprises the transmitter/receiver 416 (comprising the antenna 460), the receiving processor 412, the transmitting processor 415 and the controller/processor 440 in FIG. 4 of the present application; the first transmitter 1302 comprises the transmitter/receiver 416 (comprising the antenna 460), the transmitting processor 415 and the controller/processor 440 in FIG. 4 of the present application.

In Embodiment 13, the second transceiver 1301 transmits a first information block and transmits a second information block, the first information block being used to indicate a first RE set, the first RE set comprising at least one RE, and any RE in the first RE set being used for first-type reference signals; and the first transmitter 1302 transmits control channel candidates in a first control resource set, the first control resource set comprising multiple REs, and the first control resource set comprising at least one RE being used for second-type reference signals, the second-type reference signals and the first-type reference signals being two different types of reference signals, the second-type reference signals being used for demodulation of control channels; herein, the second information block is used to indicate a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set.

In one embodiment, the first information block comprises a first sub-information-block and a second sub-information-block, the first sub-information-block being used to determine a number of antenna ports of the first-type reference signals, the second sub-information-block being used to determine a frequency-domain location of REs comprised by the first RE set, and at least one of the number of the antenna ports of the first-type reference signals or the frequency-domain location of the REs comprised by the first RE set being used to determine the characteristic relationship between the first relationship or the second relationship.

In one embodiment, the second information block is used to determine precoding granularity of the first control resource set, and a number of the time-frequency units in the characteristic resource subset is related to the precoding granularity of the first control resource set.

In one embodiment, the second transceiver 1301 receives a third information block; herein, the third information block is used to indicate a capability of the first node, and at least one of the capability of the first node or an index of the first control resource set is used to determine the characteristic relationship between the first relationship or the second relationship.

In one embodiment, the precoding granularity of the first control resource set refers to all contiguous RBs, and a number of non-contiguous RB subset(s) included in the first control resource set in frequency domain is no greater than a first threshold, the first threshold being a positive integer greater than 1; the first threshold is fixed, or the first threshold is related to whether the characteristic relationship is the first relationship or the second relationship.

In one embodiment, the first information block is used to indicate at least one of whether there is quasi-colocation between the first-type reference signals and the second-type reference signals, or the type of quasi-colocation relationship between the first-type reference signals and the second-type reference signals.

In one embodiment, the second transceiver 1301 transmits a fourth information block; herein, a first quantity value is equal to a number of time-domain symbols occupied in time domain by the first control resource set, and a number of time-domain symbols occupied in time domain by the characteristic resource subset is equal to the first quantity value; the fourth information block is used to indicate a target quantity set, the target quantity set including multiple quantity values, and the second information block is used to determine the first quantity value out of the target quantity set; the first quantity value is used to determine the characteristic relationship between the first relationship or the second relationship.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node or the second node, or UE or terminal includes but is not limited to mobile phones, tablet computers, notebooks, network cards, low-consumption equipment, enhanced MTC (eMTC) terminals, NB-IoT terminals, vehicle-mounted communication equipment, aircrafts, diminutive airplanes, unmanned aerial vehicles, telecontrolled aircrafts, etc. The base station or network equipment in the present application includes but is not limited to macro-cellular base stations, micro-cellular base stations, home base stations, relay base station, eNB, gNB, Transmitter Receiver Point (TRP), relay satellite, satellite base station, airborne base station and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first transceiver, receiving a first information block and receiving a second information block, the first information block being used to determine a first RE set, the first RE set comprising at least one RE, and any RE in the first RE set being used for first-type reference signals; and
a first receiver, monitoring control channel candidates in a first control resource set, the first control resource set comprising multiple REs, and the first control resource set comprising at least one RE being used for second-type reference signals, the second-type reference signals and the first-type reference signals being two different types of reference signals, the second-type reference signals being used for demodulation of control channels;
wherein the second information block is used to determine a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set.

2. The first node according to claim 1, characterized in that the first information block comprises a first sub-information-block and a second sub-information-block, the first sub-information-block being used to determine a number of antenna ports of the first-type reference signals, the second sub-information-block being used to determine a frequency-domain location of REs comprised by the first RE set, and at least one of the number of the antenna ports of the first-type reference signals or the frequency-domain location of the REs comprised by the first RE set being used to determine the characteristic relationship between the first relationship or the second relationship.

3. The first node according to claim 1, characterized in that the second information block is used to determine precoding granularity of the first control resource set, and a number of the time-frequency units in the characteristic resource subset is related to the precoding granularity of the first control resource set.

4. The first node according to claim 1, characterized in that the first transceiver transmits a third information block; wherein the third information block is used to indicate a capability of the first node, and at least one of the capability of the first node or an index of the first control resource set is used to determine the characteristic relationship between the first relationship or the second relationship.

5. The first node according to claim 1, characterized in that the precoding granularity of the first control resource set refers to all contiguous RBs, and a number of non-contiguous RB subset(s) included in the first control resource set in frequency domain is no greater than a first threshold, the first threshold being a positive integer greater than 1; the first threshold is fixed, or the first threshold is related to whether the characteristic relationship is the first relationship or the second relationship.

6. The first node according to f claim 1, characterized in that the first node does not expect that there exists overlapping REs between only part of time-frequency units of the characteristic resource subset and the first RE set, or the first node does not expect that there exists any overlapping RE between the characteristic resource subset and the first RE set.

7. The first node according to claim 1, characterized in that the first transceiver receives a fourth information block; wherein a first quantity value is equal to a number of time-domain symbols occupied in time domain by the first control resource set, and a number of time-domain symbols occupied in time domain by the characteristic resource subset is equal to the first quantity value; the fourth information block is used to determine a target quantity set, the target quantity set including multiple quantity values, and the second information block is used to determine the first quantity value out of the target quantity set; the first quantity value is used to determine the characteristic relationship between the first relationship or the second relationship.

8. A second node for wireless communications, comprising:
a second transceiver, transmitting a first information block and transmitting a second information block, the first information block being used to indicate a first RE set, the first RE set comprising at least one RE, and any RE in the first RE set being used for first-type reference signals; and
a first transmitter, transmitting control channel candidates in a first control resource set, the first control resource set comprising multiple REs, and the first control resource set comprising at least one RE being used for second-type reference signals, the second-type reference signals and the first-type reference signals being two different types of reference signals, the second-type reference signals being used for demodulation of control channels;
wherein the second information block is used to indicate a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set.

9. The second node according to claim 8, characterized in that the first information block comprises a first sub-information-block and a second sub-information-block, the first sub-information-block being used to determine a number of antenna ports of the first-type reference signals, the second sub-information-block being used to determine a frequency-domain location of REs comprised by the first RE set, and at least one of the number of the antenna ports of the first-type reference signals or the frequency-domain location of the REs comprised by the first RE set being used to determine the characteristic relationship between the first relationship or the second relationship.

10. The second node according to claim 8, characterized in that the second information block is used to determine precoding granularity of the first control resource set, and a number of the time-frequency units in the characteristic resource subset is related to the precoding granularity of the first control resource set.

11. The second node according to claim 8, characterized in that the second transceiver receives a third information block; wherein the third information block is used to indicate a capability of a transmitter of the third information block, and at least one of the capability of the transmitter of the third information block or an index of the first control resource set is used to determine the characteristic relationship between the first relationship or the second relationship.

12. The second node according to claim 8, characterized in that the precoding granularity of the first control resource set refers to all contiguous RBs, and a number of non-contiguous RB subset(s) included in the first control resource set in frequency domain is no greater than a first threshold, the first threshold being a positive integer greater than 1;
the first threshold is fixed, or the first threshold is related to whether the characteristic relationship is the first relationship or the second relationship.

13. The second node according to claim 8, characterized in that the second transceiver transmits a fourth information block; wherein a first quantity value is equal to a number of time-domain symbols occupied in time domain by the first control resource set, and a number of time-domain symbols occupied in time domain by the characteristic resource subset is equal to the first quantity value; the fourth information block is used to determine a target quantity set, the target quantity set including multiple quantity values, and the second information block is used to determine the first quantity value out of the target quantity set; the first quantity value is used to determine the characteristic relationship between the first relationship or the second relationship.

14. A method in a first node for wireless communications, comprising:
receiving a first information block and receiving a second information block, the first information block being used to determine a first RE set, the first RE set comprising at least one RE, and any RE in the first RE set being used for first-type reference signals; and
monitoring control channel candidates in a first control resource set, the first control resource set comprising multiple REs, and the first control resource set comprising at least one RE being used for second-type reference signals, the second-type reference signals and the first-type reference signals being two different types of reference signals, the second-type reference signals being used for demodulation of control channels;
wherein the second information block is used to determine a characteristic resource subset, the characteristic resource subset comprising multiple time-frequency units, any time-frequency unit comprised in the characteristic resource subset comprises multiple REs, and any RE comprised in the characteristic resource subset belongs to the first control resource set; the characteristic resource subset and the first RE set are in a relationship other than a characteristic relationship, the characteristic relationship being one of a first relationship or a second relationship; the first relationship includes that there exists at least one overlapping RE between only part of time-frequency units of the characteristic resource subset and the first RE set, while the second relationship includes that there exists at least one overlapping RE between the characteristic resource subset and the first RE set.

15. The method according to claim 14, characterized in that the first information block comprises a first sub-information-block and a second sub-information-block, the first sub-information-block being used to determine a number of antenna ports of the first-type reference signals, the second sub-information-block being used to determine a frequency-domain location of REs comprised by the first RE set, and at least one of the number of the antenna ports of the first-type reference signals or the frequency-domain location of the REs comprised by the first RE set being used to determine the characteristic relationship between the first relationship or the second relationship.

16. The method according to claim 14, characterized in that the second information block is used to determine precoding granularity of the first control resource set, and a number of the time-frequency units in the characteristic resource subset is related to the precoding granularity of the first control resource set.

17. The method according to claim 14, characterized in comprising:
transmitting a third information block;
wherein the third information block is used to indicate a capability of the first node, and at least one of the capability of the first node or an index of the first control resource set is used to determine the characteristic relationship between the first relationship or the second relationship.

18. The method according to claim 14, characterized in that the precoding granularity of the first control resource set refers to all contiguous RBs, and a number of non-contiguous RB subset(s) included in the first control resource set in frequency domain is no greater than a first threshold, the first threshold being a positive integer greater than 1; the first threshold is fixed, or the first threshold is related to whether the characteristic relationship is the first relationship or the second relationship.

19. The method according to claim 14, characterized in that the first node does not expect that there exists overlapping REs between only part of time-frequency units of the characteristic resource subset and the first RE set, or the first node does not expect that there exists any overlapping RE between the characteristic resource subset and the first RE set.

20. The method according to claim 14, characterized in comprising:
receiving a fourth information block;
wherein a first quantity value is equal to a number of time-domain symbols occupied in time domain by the first control resource set, and a number of time-domain symbols occupied in time domain by the characteristic resource subset is equal to the first quantity value; the fourth information block is used to determine a target quantity set, the target quantity set including multiple quantity values, and the second information block is used to determine the first quantity value out of the target quantity set; the first quantity value is used to determine the characteristic relationship between the first relationship or the second relationship.
